(19) United States
(12) Patent Application Publication
(10) Pub. No.: US 2017/0372442 A1
(43) Pub. Date: Dec. 28, 2017

(54) HEALTHCARE WORKFLOW SYSTEM

(71) Applicant: RADICALOGIC TECHNOLOGIES, INC., Toronto (CA)

(72) Inventor: Alexiel MEJIAS, Courtice (CA)

(21) Appl. No.: 15/631,789

(22) Filed: Jun. 23, 2017

Related U.S. Application Data
(60) Provisional application No. 62/353,707, filed on Jun. 23, 2016.

(51) Int. Cl. G06Q 50/24; G06F 19/00; G06Q 50/22

(52) U.S. Cl. CPC G06Q 50/24; G06Q 50/22; G06F 19/32; G06F 19/325; G06F 19/345

(57) ABSTRACT

A healthcare workflow system with a healthcare workflow robot and a rules engine that responds to events relating to healthcare data received or updated by a form interface. A rule interception component monitors healthcare data updates and in response adds event entries to an event queue to activate the healthcare workflow robot and initiate the execution of rules. The rules engine manages a set of rules with stored instructions to process data and send notifications. A workflow designer interface provides visual elements to create and update rules contained in the set of rules to be executed upon changes to the healthcare data.

### CROSS REFERENCE

This application is a non-provisional of U.S. Application No. 62/353,707, entitled “HEALTHCARE WORKFLOW SYSTEM”, filed Jun. 23, 2016, herein incorporated by reference and all benefit, including priority is claimed.

### FIELD

The embodiments described herein relate generally to the field of healthcare systems and more specifically to computer-implemented healthcare workflow robots.

### INTRODUCTION

The organization and administration of health care data is important to different types of heath care facilities. A workflow system that runs automated and predefined tasks based on changes to a dataset in a healthcare facility provides efficiency gains and increases service quality through the creation and modification of files, messages and notifications that may be automatically executed. In the health care sector, data processing and automated notifications lead to improved patient safety and health outcomes. A healthcare workflow system therefore, reduces both the margin of human error (e.g. forgotten deadlines, incorrect categorized patient file data) and the time associated with performing these tasks.

### SUMMARY

An improved healthcare workflow system is described that is implemented using workflow robots. Systems and methods are also provided for configuring and managing the workflow robots as the workflow robots execute actions in accordance with workflows states, transitioning between a plurality of states as events are received and actions are taken. Automated state management and conflict management is provided, in some embodiments, in accordance with priority-based resolution.

The healthcare workflow system utilizes automated workflow robots to run automated and predefined tasks based on changes to a dataset, as received by event listener. The automated workflow robots are specially configured for operation in the healthcare industry, improving process flow and efficiency. The automated workflow robots are implemented by processors working in conjunction with computer-readable memories, having machine-readable instructions stored thereon, which when executed, cause the processors to perform various steps, and the automated workflow robots operate free of human intervention.

In accordance with an aspect, there is a healthcare workflow robot with a processor and a persistent data store with machine-readable instructions to configure the processor to provide: a form engine to generate a form interface to receive or update healthcare data for the persistent data store; a rules engine interception component to: detect events through an application programming interface, an auxiliary business logic layer, or an auxiliary data access layer, the events based on received or updated healthcare data from the form interface; store event entries for the detected events to an events queue stored in the persistent data store, the event entries include data indicating changes that have been made to files and/or non-file-related actions; and activate the workflow robot when the event entries are stored to the events queue; a rules engine to: identify a set of rules stored in the persistent data store in response to activation of the robot by the rule engine interception component or upon expiration of a time, each rule having a trigger and an action, the action relating to the healthcare data in the persistent data store; iterate the set of rules to evaluate each rule for execution of the action of the rule based on the event entries and the trigger of the rule; and a workflow designer interface to generate visual elements for creating, modifying and deleting a rule of the set of rules by creating, modifying and deleting logical expressions for the trigger and the action using the visual elements.

In accordance with another aspect, each rule of the set of rules includes a plurality of states, each state having a set of triggers, actions, and one or more linkages to other states; and when evaluating each rule for execution, a current state of the rule is used to apply a corresponding trigger and a corresponding action for evaluation.

In accordance with another aspect, execution of the action of the rule includes transitioning one or more rules of the set of rules from a current state to another state.

In accordance with another aspect, each action is associated with a priority ranking; evaluation of each rule for execution of the action includes identifying conflicts between the execution of the action and the execution of other actions; and the priority ranking of each action is utilized to determine which actions should be executed and which actions should be ignored.

In accordance with another aspect, the workflow robot further including a binary executable encapsulation engine, the binary executable encapsulation engine configured to activate the rules engine to iterate the set of rules to identify a complete set of actions and triggers indicative of the current states of all rules; and encapsulate a point-in-time binary executable representative of the complete set of actions and triggers, the point-in-time binary executable used for the activation of the workflow robot to execute the actions in response to events.

In accordance with another aspect, the complete set of actions is representative only of the actions identified for execution in accordance with the priority ranking of each action.

In accordance with another aspect, the binary executable encapsulation engine is configured to regenerate a new point-in-time binary executable when new event entries are intercepted.

In accordance with another aspect, the regeneration a new point-in-time binary executable when new event entries are intercepted only occurs when a state transition is executed.

In accordance with another aspect, the workflow robot including an alert engine to generate an alert notification based in the action relating to the health care data.

In accordance with another aspect, the rules interception component adds event entries to the event queue asynchronously to the robot processing the event entries.

In accordance with another aspect, a process for execution of file-related rules by a healthcare workflow robot is provided. The process involves: polling an event queue for new event entries or receiving a signal indicating one or more new event entries in the event queue; locking a file in a data store; creating or determining a batch set of rules based on the one or more new event entries in the event queue; ordering the batch set of rules based on a predefined parameter; iterating through the batch set of rules to evaluate a trigger on each rule, execute an action if the trigger is met, and determine whether all rules have been executed; examining whether a dataset of the data store has been changed during execution of the rules and re-initiating execution of the batch set of rules if the dataset of the database has changed; and unlocking the file in the data store.

In accordance with another aspect, a healthcare workflow system is provided with a rules engine residing within a healthcare workflow robot that has or integrates with a form engine that renders a form interface for a user device to generate a form, wherein the form creates, modifies and deletes healthcare data associated with patient files, the healthcare data passing through one or more layers of the healthcare workflow robot including application programming interfaces, business logic layers and data access layers before being saved to the database; and a rules interception component that intercepts the healthcare data related to the patient files as it passes from business logic and data access layers of the healthcare workflow robot, upon intercepting such data, creates event entries in the event queue, and sends a signal to activate the healthcare workflow robot indicating that new event entries are in the event queue, the healthcare workflow robot processing the event entries using the rules engine to evaluate and execute rules for a particular file associated with the intercepted data and event entries.

In accordance with another aspect, the rules interception component adds event entries to the event queue asynchronously to the workflow robot processing the event entries.

In accordance with another aspect, a workflow designer interface is provided for creating and updating rules for a healthcare workflow robot, the rules evaluated in response new event entries in the event queue, the event entries for additions, updates and deletions to healthcare data in a persistent data store by a form interface on a client device, the workflow designer interface has at least two visual panels to create and update rules for the rules engine using graphical or visual elements representing states, triggers, conditions and connections.

In accordance with another aspect, the rules created through the workflow designer interface are precompiled into machine-readable code after an administrator device creates or modifies the rules.

In accordance with another aspect, the workflow designer interface defines a priority sequence for the rules in a rule-execution workflow.

In accordance with another aspect, a rules engine is provided for use in a healthcare workflow robot with: a rules engine interception component that: listens for impending changes to files in a database performed by a file save business logic layer and a file save data access layer and the execution of non-file-related actions through an auxiliary business logic layer and an auxiliary data access layer of the workflow robot; saves to an event queue of event entries, each event entry having data indicating changes that have been made to the files in the database and/or non-file-related actions that have been performed by the workflow robot; and allows the impending changes to the files in the database to proceed; the event queue in which the rules engine interception component stores the event entries; a set of rules for which execution thereof is initiated by the rules engine polling the event queue of event entries for new event entries or activation of the workflow robot in response to the new event entries in the event queue, each rule having a trigger to be evaluated for execution of an action, the action to modify files in the data store based on the content of the event entry and the result of the evaluation of the trigger, wherein the rules engine iterates the set of rules after discovering new event entries in the event queue; and a workflow designer interface configured to create, modify and delete rules for the rules engine using visual elements representing components of the rules.

In accordance with another aspect, the workflow designer interface is comprised of at least two visual panels, the first of which contains workflow objects and logical operands that are adapted to be dragged and dropped to the second panel in order to form logical expressions for the rules.

In accordance with another aspect, the rules created through the workflow designer interface are precompiled into machine-readable code after the administrator creates or modifies the rules.

In accordance with another aspect, a rule of the rules created through the workflow designer interface includes data indicating the priority of that rule in a rule-execution workflow.

In accordance with one aspect, there is provided healthcare workflow robot with a rules engine and a rules engine interception component that listens for events, such as impending changes to files in a database performed by a file save business logic layer and/or a file save data access layer and the execution of non-file-related actions, through an auxiliary business logic layer and/or auxiliary data access layer of the workflow robot. The rules engine interception component saves detected events to a queue of events as event entries. The event entries include data indicating changes that have been made to the files in the database and/or non-file-related actions that have been performed by the workflow robot. The rules engine interception component allows the impending changes to the files in the database to proceed. The healthcare workflow robot activates when new event entries are added to the queue of events or upon expiration of a timer. The rules engine interception component stores event entries in the queue of events. The rules engine manages a set of rules for which execution thereof is initiated by the workflow robot polling the queue of events for new event entries. The workflow robot interacts with the rules engine to iterate the set of rules after discovering new event entries in the queue of events. The rules contain triggers (or conditions) and actions. The triggers are evaluated prior to the rule being executed by the rules engine. The rules contain instructions to perform predefined actions, where an example action modifies files in the database based on the content of the event and the result of the evaluation of the trigger. The workflow robot interacts with a workflow designer interface that provides a user interface through which an administrator device may create, modify and delete rules for the rules engine by creating logical expressions for the triggers or conditions and the actions.

In accordance with another aspect, there is provided a process for the execution of file-related rules by the workflow robot that includes: polling an event queue for new event entries or receiving a signal indicating one or more new event entries in the event queue; locking a file in a database; creating or determining a batch set of rules based on the new event entries in the event queue; ordering the batch set of rules based on a predefined parameter; iterating through the batch set of rules to evaluate a trigger on each rule, execute an action if the trigger is met, and determine whether all rules have been executed; examining whether a dataset of the database has been changed during execution of the rules and re-initiating execution of the rules if the dataset of the database has changed; unlocking the file in the database; and exiting.

In some embodiments, the rules engine may be situated within a healthcare workflow robot that has or integrates with a form engine that renders forms to user devices, where forms may create, modify and delete data associated with patient files. Such data may be passed through various layers of the healthcare workflow robot such as application programming interfaces, business logic layers and data access layers before being saved to the database. In some embodiments, the rules interception component may intercept data related to a particular file as it passes from business logic and data access layers of the workflow robot. Upon intercepting such data, the rules interception component may create event entries in the event queue and send a signal to the workflow robot indicating that new event entries are in the event queue. The workflow robot process the event entries using the rules engine to evaluate and execute rules for the particular file associated with the intercepted data and event entries. The workflow robot may then allow the intercepted data to pass through to the database.

In some embodiments, the rules interception component adds event entries to the event queue asynchronously to the workflow robot processing the event entries. Accordingly, new event entries can be continuously added to the event queue while the workflow robot processes event entries and evaluates rules for execution.

In another embodiment a workflow designer interface has at least two visual panels to create and update rules for the rules engine using graphical or visual elements representing states, triggers, conditions and connections. A first panel contains workflow objects and logical operands that may be dragged and dropped to the second panel to form the logical expressions for the rules. The workflow robot evaluates and executes rules in response to new event entries in the event queue.

In another embodiment, the rules created through the workflow designer interface may be precompiled into machine-readable code after an administrator device creates or modifies the rules. In some embodiments the rules created through the workflow designer interface may include data indicating the priority of a rule in a rule-execution workflow.

In an aspect, there is provided a healthcare workflow robot with a processor and a persistent data store with machine-readable instructions to configure the processor to provide: a persistent data store to receive, store and update healthcare data; a rules engine interception component to: detect events through an application programming interface, an auxiliary business logic layer, or an auxiliary data access layer, the events based on received or updated healthcare data; store event entries for the detected events to an events queue stored in the persistent data store, the event entries include data indicating changes that have been made to files and/or non-file-related actions; and activate the workflow robot when the event entries are stored to the events queue; a rules engine to: identify a set of rules stored in the persistent data store in response to activation of the robot by the rule engine interception component or upon expiration of a time, each rule having a trigger and an action, the action relating to the healthcare data in the persistent data store, each rule of the set of rules having a plurality of states, each state having a set of triggers, actions, and one or more linkages to other states; iterate the set of rules to evaluate each rule for execution of the action of the rule based on the event entries and the trigger of the rule, wherein to evaluate each rule for execution, a current state of the rule is used to apply a corresponding trigger and a corresponding action for evaluation, wherein the execution of the rule triggers an action to transition the rule from a current state to another state; and a workflow designer interface to generate visual elements for creating, modifying and deleting a rule of the set of rules by creating, modifying and deleting logical expressions for the trigger and the action using the visual elements.

In some embodiments, each action is associated with a priority ranking; wherein evaluation of each rule for execution of the action includes identifying conflicts between the execution of the action and the execution of other actions; and wherein the priority ranking of each action is utilized to determine which actions should be executed and which actions should be ignored.

In some embodiments, the healthcare workflow robot has a binary executable encapsulation engine, the binary executable encapsulation engine configured to activate the rules engine to iterate the set of rules to identify a complete set of actions and triggers indicative of the current states of all rules; and encapsulate a point-in-time binary executable representative of the complete set of actions and triggers, the point-in-time binary executable used for the activation of the workflow robot to execute the actions in response to events.

In some embodiments, the set of actions is representative only of the actions identified for execution in accordance with the priority ranking of each action.

In some embodiments, the binary executable encapsulation engine is configured to regenerate a new point-in-time binary executable when new event entries are intercepted.

In some embodiments, the regeneration a new point-in-time binary executable when new event entries are intercepted only occurs when a state transition is executed.

In some embodiments, the healthcare workflow robot has an alert engine to generate an alert notification based in the action relating to the health care data.

In some embodiments, the rules interception component adds event entries to the event queue asynchronously to the robot processing the event entries.

In an aspect, there is provided a process for execution of file-related rules by a healthcare workflow robot. The process involves: polling an event queue for new event entries or receiving a signal indicating one or more new event entries in the event queue; locking a file in a data store; creating or determining a batch set of rules based on the one or more new event entries in the event queue, each rule of the set of rules having a plurality of states, each state having a set of triggers, actions, and one or more linkages to other states; ordering the batch set of rules based on a plurality of parameters; iterating through the batch set of rules to evaluate a trigger on each rule, execute an action if the trigger is met, and determine whether all rules have been executed, wherein to evaluate each rule for execution, a current state of the rule is used to apply a corresponding trigger and a corresponding action, wherein the execution of the rule triggers an action to transition the rule from a current state to another state; examining whether a dataset of the data store has been changed during execution of the rules and re-initiating execution of the batch set of rules if the dataset of the database has changed; and unlocking the file in the data store.

In an aspect, there is provided a healthcare workflow system with: a rules engine integrated with a healthcare workflow robot to monitor for creation, modification and deletion of healthcare data associated with patient files, the healthcare data passing through one or more layers of the healthcare workflow robot including application programming interfaces, business logic layers and data access layers before being saved to the database; and a rules interception component that intercepts the healthcare data related to the patient files as it passes from business logic and data access layers of the healthcare workflow robot, upon intercepting such data, creates event entries in the event queue, and sends a signal to activate the healthcare workflow robot indicating that new event entries are in the event queue, the healthcare workflow robot processing the event entries using the rules engine to evaluate and execute rules for a particular file associated with the intercepted data and event entries, each rule of the set of rules having a plurality of states, each state having a set of triggers, actions relating to the healthcare data in the persistent data store, and one or more linkages to other states, wherein to evaluate each rule for execution, a current state of the rule is used to apply a corresponding trigger and a corresponding action for evaluation, wherein the execution of the rule triggers an action to transition the rule from a current state to another state.

In some embodiments, the rules interception component adds event entries to the event queue asynchronously to the workflow robot processing the event entries.

In an aspect, there is provided a workflow designer interface for creating and updating rules for a healthcare workflow robot, the rules evaluated in response new event entries in the event queue, the event entries for additions, updates and deletions to healthcare data in a persistent data store, the workflow designer interface comprising a visual panel to create and update rules for the rules engine using graphical or visual elements representing states, triggers, conditions and connections of executed rules, each rule of the set of rules having a plurality of states, each state having a set of triggers, actions, and one or more linkages to other states, wherein to evaluate each rule for execution, a current state of the rule is used to apply a corresponding trigger and a corresponding action for evaluation, wherein the execution of the rule triggers an action to transition the rule from a current state to another state.

In some embodiments, the rules created through the workflow designer interface are precompiled into machine-readable code after an administrator device creates or modifies the rules.

In some embodiments, the workflow designer interface defines a priority sequence for the rules in a rule-execution workflow.

In an aspect, there is provided a rules engine for use in a healthcare workflow robot with: a rules engine interception component configured to: listen for impending changes to health care files in a database performed by a file save business logic layer and a file save data access layer and the execution of non-file-related actions through an auxiliary business logic layer and an auxiliary data access layer of the workflow robot; save to an event queue of event entries, each event entry comprising data indicating changes that have been made to the files in the database and/or non-file-related actions that have been performed by the workflow robot; and allow the impending changes to the files in the database to proceed; the event queue for storing the event entries; a set of rules for which execution thereof is initiated by the rules engine polling the event queue of event entries for new event entries or activation of the workflow robot in response to the new event entries in the event queue, each rule having a trigger to be evaluated for execution of an action, the action to modify files in the data store based on the content of the event entry and the result of the evaluation of the trigger, wherein the rules engine iterates the set of rules after discovering new event entries in the event queue, each rule of the set of rules having a plurality of states, each state having a set of triggers, actions, and one or more linkages to other states, wherein to evaluate each rule for execution, a current state of the rule is used to apply a corresponding trigger and a corresponding action for evaluation, wherein the execution of the rule triggers an action to transition the rule from a current state to another state; and a workflow designer interface configured to create, modify and delete rules for the rules engine using visual elements representing components of the rules.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments of the invention are illustrated by way of example. It is to be expressly understood that the description and figures are only for the purpose of illustration and as an aid to understanding, and are not intended as a definition of the limits of the invention.

Embodiments will now be described, by way of example only, with reference to the attached figures, wherein in the figures:

FIG. 1 is a diagram of an example healthcare workflow system according to some embodiments;

FIG. 2 is a diagram of another example healthcare workflow system according to some embodiments;

FIG. 3 is a diagram of a further example healthcare workflow system according to some embodiments;

FIG. 4 is a diagram of another example healthcare workflow system according to some embodiments;

FIG. 5 is a diagram for a rule of the rules engine;

FIG. 6 is a diagram for another rule of the rules engine based on a machine state expression;

FIG. 7 is a flow diagram of a process an example healthcare workflow system according to some embodiments;

FIG. 8 is a diagram of a computing device, which may be used to implement aspects of some embodiments.

FIG. 9 is a diagram of another example healthcare workflow system and dataflow according to some embodiments;

FIG. 10 is a diagram of example visual elements a workflow designer interface for creating or updating rules according to some embodiments;

FIGS. 11 and 12 diagrams of example visual elements of an aspect of the workflow designer interface to edit rule state connectors according to some embodiments;

FIG. 13 is a diagram of example visual elements of another aspect of the workflow designer interface;

FIG. 14 is a diagram of an example rule data structure;

FIG. 15 is a diagram of an example events queue data structure;

FIG. 16 is a diagram of an example rule state data structure; and

FIG. 17 is a diagram of another example healthcare workflow system and dataflow according to some embodiments.

### DETAILED DESCRIPTION

Embodiments of methods, systems, and apparatus are described through reference to the drawings.

Workflow robots are configured to implement robotic process automation to invoke automated mechanisms for automatically executing one or more actions. These actions, for example, may be in the form of generated control commands that are adapted for interfacing with various user interfaces, and in some embodiments, the actions are further adapted to operate on the user interfaces in a same or similar method as would be undertaken by a user. Workflow robots provide significant benefits as workflow robots are not susceptible to human error, and are able to perform tasks and implement rule-based procedures without overhead or human-based limitations (e.g. time of day, availability). Workflow robots are able to handle tasks that are tedious and time consuming, with a higher level of accuracy due to the large number of keystrokes necessary to perform actions. Accordingly, increased data integrity and process integrity can be achieved.

To achieve these benefits, workflow robots are configured using computer implementation to include or operate in conjunction with rules/policy engines, alert engines, data storage, event listeners, rule engine interception components, application programming interfaces, among others. Workflow robots can be operated responsively to sensed modifications or changes to various systems or data structures (e.g. intercepted by a rule engine interception component intercepting data saved or modified on a form or data structure), and may be configured to provide a policy engine that invokes various actions based on the sensed modifications or changes (e.g. modification of underlying profile data stored on data structures or data storage, such as a patient object's status, executing further save commands, executing database commands).

As described below, workflow robots may reside in on a centralized healthcare workflow system, on a user device, or on both. There may be multiple workflow robots, in some embodiments, working in concert. For example, a workflow robot implemented at a workflow system may interoperate with a workflow robot implemented at a user device. In an alternate embodiment, the workflow robots are provided in the form of a distributed computing resource implementation whereby the workflow robots are generated or instantiated in accordance with cloud-based resources being provisioned or de-provisioned. Workflow robot usage can be resource intensive; in any large-scale system, there are limited computing resources and computational time available, and workflow robots must operate within these technical constraints. Accordingly, efficient processing is a desirable outcome, and in some embodiments described herein, technical approaches to coordinate and simplify execution are provided.

Workflow robots are especially useful in the healthcare industry. In the healthcare industry, record keeping requirements, regulatory requirements and legacy systems, among others, lead to a significantly increased administrative burden (for example, in relation to tracking documentation for claims processing, patient tracking, device tracking, practitioner tracking, pharmaceutical inventory management). Workflow robots can be used, for example, as a first line in automatically triaging patients, maintaining patient records, conducting preliminary diagnoses, generating notifications, among others. However, workflow robots, unlike humans, are not able to make value judgments. In sophisticated, large-scale workflow implementations, conflict resolution and the interpretation of contextual considerations is required.

In accordance with various embodiments, an improved healthcare workflow system is described that is implemented using workflow robots. Systems and methods are also provided for configuring and managing the workflow robots as the workflow robots execute actions in accordance with workflows states, transitioning between a plurality of states as events are received and actions are taken. Automated state management and conflict management is provided, in some embodiments, in accordance with priority-based resolution. These computerized, automated state management and conflict management present technical solutions to issues of conflict resolution and the interpretation of contextual considerations.

Corresponding data structures, and graphical user interfaces are described. Improved data structures may be utilized to efficiently represent configurations of the workflow robots, including, for example, linkages between rules, actions to be taken, and objects representing rules and/or other field values. Graphical user interfaces are described that are updated in accordance with the current state of the workflows as they are executed by the workflow robots.

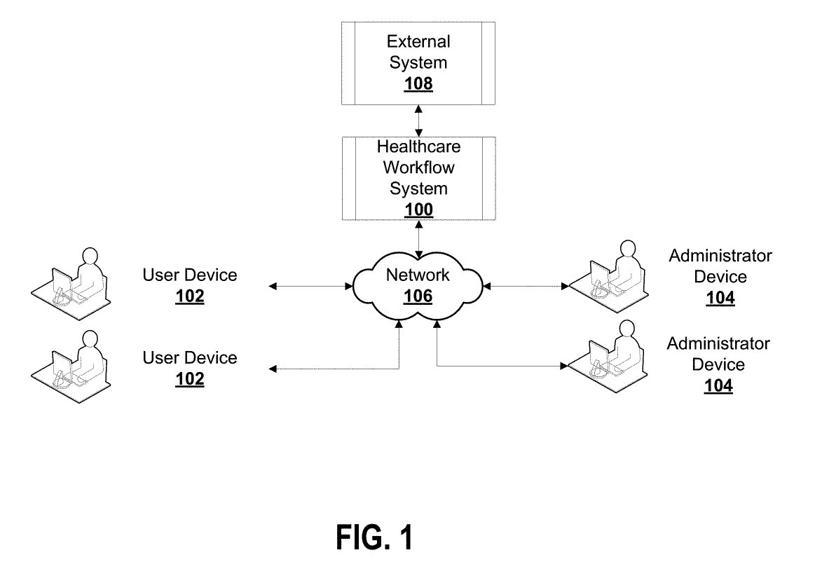

FIG. 1 is a diagram of an example healthcare workflow system 100 according to some embodiments.

Healthcare workflow system 100 provides an infrastructure for configuration and implementation of sequences of tasks for one or more health care facilities, where the sequences of tasks are arranged as workflows. The tasks may relate to creating or updating healthcare data files, transmitting messages and alert notifications, executing routines, activating hardware components such as data capture devices, validating data, and so on. Healthcare workflow system 100 implements different workflows for different types of jobs or processes. Healthcare workflow system 100 assigns different devices or users different tasks of the sequences of tasks defining the workflows. Once a task is complete, healthcare workflow system 100 implements other tasks based on the sequences of tasks for different workflows. The sequences of tasks may have complex dependencies involving different devices and users.

Healthcare workflow system 100 couples to user device 102 rendering a form to receive or transmit healthcare data by form fields to activate workflows or as part of a task for a workflow. Healthcare workflow system 100 couples to administrator devices 104 via network 106 to receive or transmit healthcare data and configure rules for workflows to create or update tasks, for example. Healthcare workflow system 100 also connects to external systems 108 to receive or transmit healthcare data to implement or activate workflows and tasks.

Healthcare workflow system 100 connects to other components in various ways including directly coupled and indirectly coupled via the network 106. Network 106 (or multiple networks) is capable of carrying data. Network 106 can involve wired connections, wireless connections, or a combination thereof. Network 106 may involve different network communication technologies, standards and protocols, such as for example Global System for Mobile Communications (GSM), Code division multiple access (CDMA), wireless local loop, WMAX, Bluetooth, Long Term Evolution (LTE) and so on. Network 106 may involve different physical media such as coaxial cable, fiber optics, transceiver stations and so on. Example network types include the Internet, Ethernet, plain old telephone service (POTS) line, public switched telephone network (PSTN), integrated services digital network (ISDN), digital subscriber line (DSL), and others, including any combination of these. Network 106 can be a local area network or wide area network.

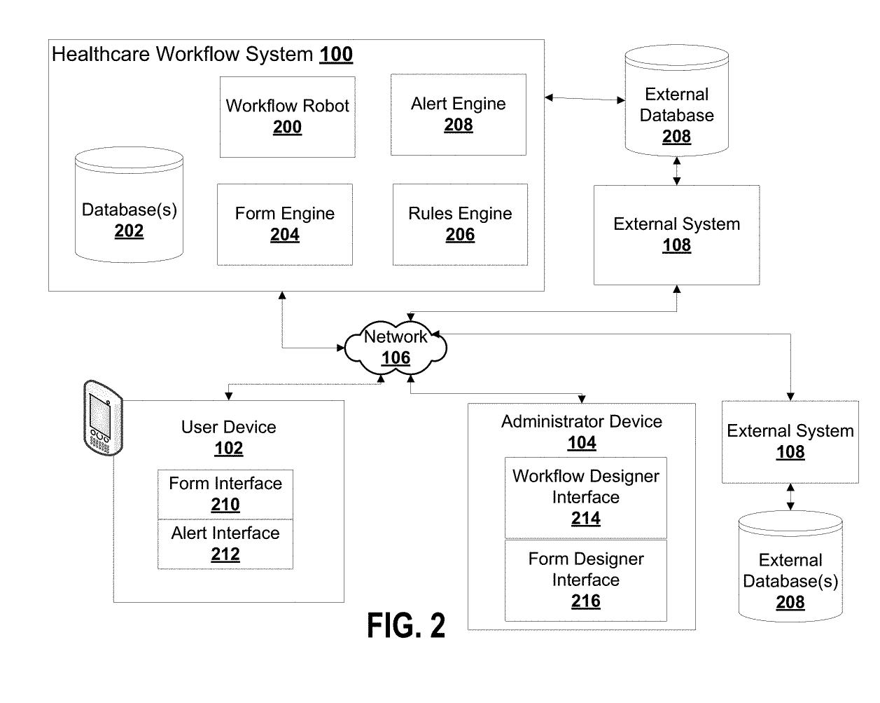

FIG. 2 is a diagram of another example healthcare workflow system 100 according to some embodiments.

Healthcare workflow system 100 has a database 202 storing healthcare data, rules, an event queue of event entries, rules, and other data. Healthcare workflow system 100 has a workflow robot 200 which is a virtual agent implemented by a computing device guided or instructed by rules. The workflow robot 200 evaluates and executes rules to automatically implement workflows for one or more healthcare facilities. Healthcare workflow system 100 has a rules engine 206 to create and manage the rules. Healthcare workflow system 100 interacts with workflow designer interface 214 on administrator device 104 to create and update rules using visual elements rendered as part of the workflow designer interface 214. The workflow designer interface 214 generates visual elements for creating, modifying and deleting rules and provides rule configurations to the rule engines 206 to create, modify and delete rules in the database 202.

Healthcare workflow system 100 has a form engine 204 that interacts with a form interface 210 to render forms having form fields and corresponding form field values to receive and transmit healthcare data. The form interface 210 creates or updates healthcare data in database 202. Modifications, deletions and additions to the healthcare data in database 202 are events that activate the workflow robot 200 to evaluate and execute rules for automatically implementing the workflows for healthcare facilities. The form engine 204 interacts with a form designer interface 216 to create, customize and configure forms (and form fields) rendered by the form interface 210.

The rules engine 206 or form engine 204 detects events based on received or updated healthcare data from the form interface 210. The rules engine 206 or form engine 204 stores event entries for the detected events to an events queue stored in database 202. In some embodiments, database 202 is configured to store one or more state-based workflows, and data sets representative of rule states as a workflow robot traverses through the one or more rule sets where the rule sets include rule states that drive the underlying triggers and actions for execution of the rules. In this embodiment, the rules engine 206 is configured to traverse through rule states of the various rules. As events are intercepted and in accordance with triggers (e.g. conditions), various actions may be performed by the workflow robot 200, including transition to a next state of execution, where the triggers may be different. The states need not be traversed by the workflow robot and the rules engine 206 in a linear manner.

A single state may, for example, transition to one or more of a plurality of different states depending on different triggers. This is particularly useful in a healthcare context, where contextual factors lead to different administrative and/or treatment processes (e.g. triage). States, for example, may be directed to the generation of alerts, the invocation of processes that lead to the performing of tasks, the rendering of different interface elements, the updating of records, the toggling or setting of flags (e.g. status flags), the tracking of milestones, the assignment of form field owners, the assignment of healthcare practitioners, the generation of notifications (e.g. email or SMS alerts), among others.

States may also be utilized for exception handling. Where an exception is caught or intercepted, the workflow robot 200 may be configured to recognize a state transition triggered by the exception, and may transition a rule into an error or exception state. In some embodiments, where the workflow robot 200 has transitioned a rule into an error or exception state, workflow robot 200 may generate one or more notifications indicative of intervention required. In other embodiments, where the workflow robot 200 has transitioned a rule into an error or exception state, workflow robot 200 is adapted to intercept events that are used to transition the rule out of the error or exception state, and automatically return the rule into a non-error or exception state.

The event entries include data indicating changes that have been made to files and/or non-file-related actions. The workflow robot 200 activates when the event entries are stored to the events queue or upon expiration of a timer, for example. The rules engine 206 identifies a set of rules stored in the database 202 in response to activation of the workflow robot 200. Each rule has a trigger and an action relating to the healthcare data in the database 202. The workflow robot 200 iterates the set of rules to evaluate the trigger of each rule for execution of the action of the rule based on the event entries. The database 202 may be a file structure storing programmatic objects, each object having interactive fields storing characteristics of triggers and actions, and the interactive fields may be populated with one or more field values. Healthcare workflow system 100 has an alert engine 208 to transmit alert notifications to an alert interface 212 on user device 102 when implementing the workflows.

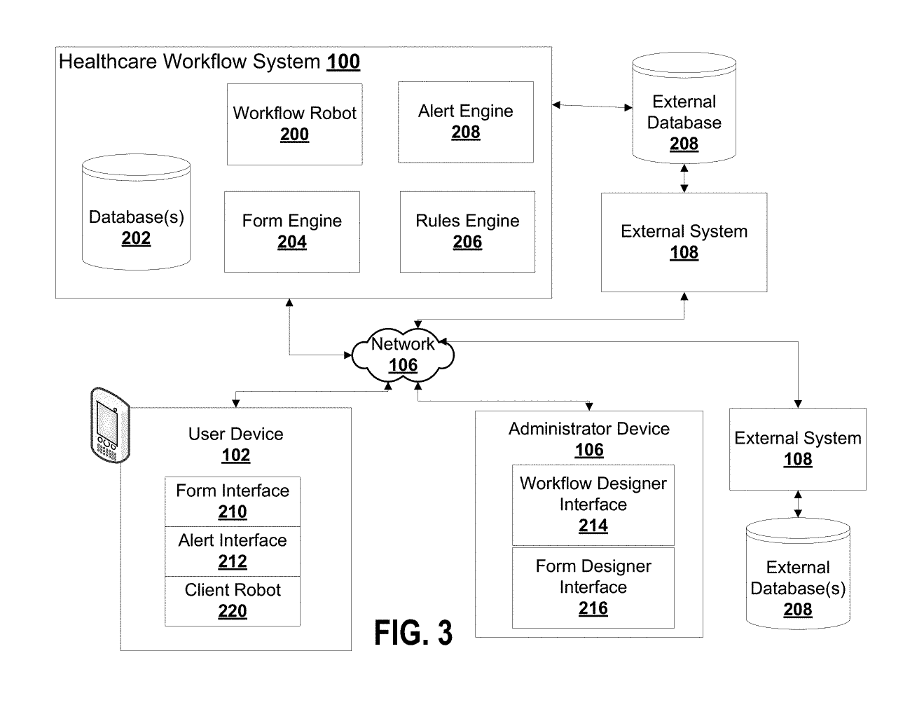

FIG. 3 is a diagram of a further example healthcare workflow system 100 according to some embodiments. User device 103 has a client robot 220 to run in real-time on the user device 103 to automate implementation of the workflow. The client robot 220 can be a stand-alone component that functions similarly to workflow robot 200 or can interact with workflow robot 200 to automate implementation of workflows. For example, the client robot 220 can run in real-time while a patient file is open (i.e. being edited through the form interface 210). Rules may be compiled to one or more languages for use by the client robot 220. The client robot 220 may interoperate with workflow robot 200 such that the robots 200 and 220 operate in concert in performing actions in accordance with defined rules as provided by database 202, the workflow robot 200 effecting actions in relation to the healthcare workflow system 100, and the client robot 220 effecting actions in relation to the user device 102.

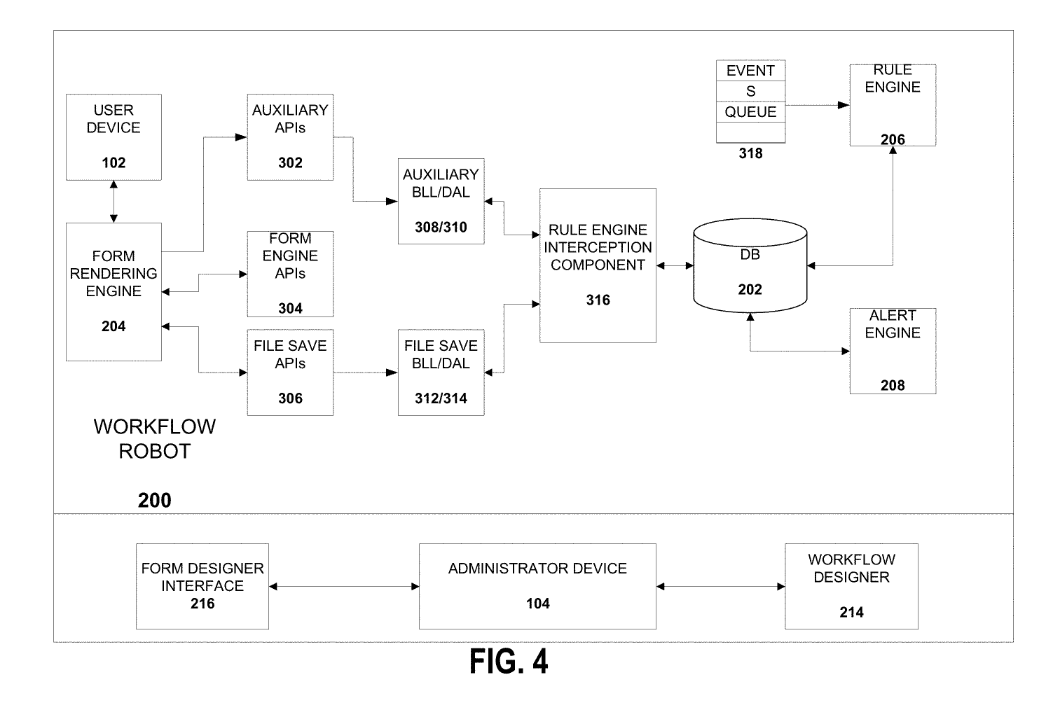

FIG. 4 is a diagram of another example healthcare workflow robot 200 according to some embodiments. Components shown in FIG. 4 are also shown in other figures. Descriptions of these components in relation to FIG. 4 apply to the other figures in various embodiments.

In some embodiments, the workflow robot 200 contains a rules engine 206 for performing automated tasks on healthcare data (e.g. patient file data) stored in a database 202 of a healthcare workflow system 100. The rules engine 206 may interface with a form (rendering) engine 204 of the healthcare workflow system 100. The form engine 204 may render forms as a part of a form interface 210 on a user device 102.

The form contains data related to patient files or other healthcare data stored in the healthcare workflow system 100. In some embodiments, the rules engine 206 of the workflow robot 200 is activated by the form engine 204. When data is created, changed or deleted through interaction by the form interface 210 with the form engine 204, the rules engine 206 may listen for these changes to the healthcare data and execute various predefined actions (from rules) on the patient file that was modified through the form engine 204. The rules engine 206 may also be activated by time-based criteria such as a set period of inactivity on a particular patient file. The period may be thirty minutes, for example, so as not to overburden the workflow robot 200 with polling activity. Actions performed by the rules engine 206 may include modifying healthcare data in the database 202 or issuing alert notifications and messages, among other things.

A workflow designer interface 214 interacts with the rules engine 206 to provide administrator devices 104 with a visual representation of rules for the rules engine 206. The visual representation includes various visual elements representing components of rules such as triggers, actions, and connections. Administrator devices 104 may create rules comprised of logical expressions using visual elements rendered through the workflow designer interface 212. These customized rules are executed based on certain triggers or conditions being met when data changes in the healthcare workflow system 100.

The rules engine 206 is implemented by a processor and a non-transitory computer readable storage medium storing instructions which when executed by the processor, configure the processor to perform various rules stored in the rules engine. The processor may implement one or more example operations such as: polling an events queue for information indicating that a given rule should be run, running data of the healthcare workflow system through one or more rules or instructions, and executing instructions to send various notifications.

Throughout the following discussion, numerous references will be made regarding engines, designers, interfaces, layers, or other systems formed from computing devices and components thereof. It should be appreciated that the use of such terms may be deemed to represent one or more computing devices having at least one processor configured to execute software instructions stored on a computer readable tangible, non-transitory medium. For example, an engine can include one or more computers operating as a file processing server, database server, or other type of computer server in a manner to fulfill described roles, responsibilities, or functions. One should further appreciate the disclosed computer-based algorithms, processes, methods, or other types of instruction sets can be embodied as a computer program product with a non-transitory, tangible computer readable media storing the instructions that cause a processor to execute the disclosed steps. One should appreciate that the systems and methods described herein may transform electronic signals of various data objects into representations for display on a tangible screen. One should appreciate that the systems and methods described herein involve interconnected networks of hardware devices configured to receive data using receivers, transmit data using transmitters, and transform electronic data signals using particularly configured processors.

Throughout the following discussion, references will be made regarding data access layers and business logic layers. It should be appreciated that a data access layer refers to programmatic instructions that function as an abstraction from direct interaction with a database. As an example, a data access layer may include a method to retrieve a patient's information along with all of the particular patient's files from a database. An example method for retrieving patient data using a patient identifier is GetPatientAndFilesByPatientID(patientID). This method executes commands such as, for example, SQL commands akin to the following: “SELECT*FROM patients LEFT JOIN patient_files ON patient_files.patient_id=patients.id WHERE patients.id=patientID”. A business logic layer refers to programmatic instructions and methods that function as intermediaries between the data access layer and other components of a system. For example, a business logic layer may perform various field validations on data before passing such to the data access layer.

Workflow robot 200 includes a form engine 204 that interacts with a client-side component (e.g. form interface 210) to render forms (with form fields for receiving form values) on user device 102. The form may operate in submission mode (the creation of new files) and management modes (the modification of files to add additional form fields and field values, adding follow-up actions to be taken on a file, for example). As an illustrative example, the form engine 204 may display data from a patient file stored in database 202 on user device 102 as a form (e.g. as part of form interface 210). User device 102 can submit commands to modify data in the patient file through form fields, which can be text input fields, radio buttons, drop-down pick lists and the like. When rendering a form, the form engine 204 may intercept and execute form rules that are configured by administrator device 104 through a form designer interface 214. In some embodiments, form rules provide instructions to make sections and fields of a form visible or hidden as well as other synchronous logical instructions configured in a given workflow of the workflow robot 200. Form rules may be configured using form designer 214 and stored in database 202 for access by form engine 204.

In some embodiments, the form engine 204 interacts with form engine application programming interfaces (APIs) 304 that provide definitions, constraints and rules, picklist values and the like. The form engine APIs 304 interpret, parse and send defined form rules to form engine 204 and user device 102 to render forms. Forms displayed by the form engine 204 may be designed by administrator device 104 through the form designer interface 214. The form designer interface 214 is used to design forms and configure form rules including customized or pre-defined logical expressions to configure the display, visibility (e.g. read privileges), editability (e.g. write privileges) and other features of form components.

As an illustrative example, a form rule may toggle the visibility of a form field or tab in a form. In this example, administrator device 104 may configure form rules through the form designer interface 214 that user device 102 is part of a group to permit writing to a patient file using form fields. As another example, administrator device 104 may configure form rules through the form designer interface 214 that user device 102 does not have write privileges to modify a particular form field corresponding to data entry in patient files. As a result, the form engine 204, through its form engine APIs 204 may process form rules that have been created by the administrator device 104 and hide this field from the certain user device 102 who do not have sufficient privileges to modify the data contained in the field. In some embodiments, the form engine 204 may synchronously process and execute form rules in a user device 102 session. Form rules may impact the user device's 102 real-time interaction with a particular form. Further, a form rule can transmit data to an auxiliary API 302 to execute predefined programmatic instructions.

In some embodiments, the workflow robot 200 may include file save APIs 306 for save and update requests to the database 202. The file save APIs 306 may receive data from a form, process such data and transmit such data to a file save business logic layer (FSBLL) 312 and a file save data access layer (FSDAL) 314. The FSBLL 312 may be responsible for processing logical rules related to data received from the file save APIs 306 and interfacing with the FSDAL 312 in order to save data to the database 202.

As an illustrative example of the file save APIs 306, FSBLL 312 and FSDAL 314, a user device 102 may execute a command through the form engine 204 that requires a patient's file to be updated. The form engine 204 may transmit data to the file save APIs 306. The file save APIs 306 interpret and parse the data, passing the parsed data to the FSBLL 312. The FSBLL 312 may then execute various logical rules on the parsed data. For example, if the the parsed data indicates that a patient has been discharged, the FSBLL 312 may execute logic to change a data entry in the database 202 associated with the patient file. This may be accomplished, for example, by the FSBLL 312 transmitting a signal to the FSDAL 314 to modify a patient object's status from “active” to “inactive” and executing a save command on the patient object. The FSDAL 314 may then execute database commands to update the data entry associated with the patient by, for example, setting an ‘active’ field to FALSE.

In some embodiments the workflow robot 200 may include auxiliary APIs 302. The auxiliary APIs 302 may comprise a collection of APIs that may be called directly from the form engine 204 to perform various actions resulting from execution of a form rule at user device 102. The auxiliary APIs 302 may be called without interacting with the file save APIs 306.

In some embodiments, the workflow robot 200 may include an auxiliary business logic layer (ABLL) 308 and an auxiliary data access layer (ADAL) 310. The ABLL 308 may be responsible for processing logical rules related to data received from the auxiliary APIs and interfacing with the ADAL 310 in order to save data to the database 202.

As an illustrative example of the auxiliary APIs 302, ABLL 308 and ADAL 310, a user device 102 may execute a form rule through the form engine 204 that requires a notification email to be sent. In this example, the form engine 204 may transmit a signal to a particular auxiliary API 302 that handles email notifications with data having a sender, receiver, subject and message body. After this, the auxiliary API 302 that handles email notifications may transmit such data to the ABLL 308, which may process logical rules and send an email message via simple mail transfer protocol (SMTP) or other communication protocol using the data provided by the auxiliary API 302. Upon successful execution by the ABLL 308, certain other data (information relating to the status of an email message and the time at which the email was sent, for example) may be stored in the database 202 through the ADAL 310. The ADAL 310 receives data from the auxiliary API 302 and executes database commands (SQL commands, for example) in order to save data to persistent storage of the database 202.

In some embodiments, the rules engine 206 is situated within a workflow robot 200. The rules engine 206 implements functionality described in relation to the workflow robot 200. In an aspect, the rules engine 206 listens for the occurrence of events (e.g. new event entries on the event queue) and processes the events using rules (e.g. predefined and administrator-defined). In some embodiments, the rules may have assigned priority levels to order execution of the rules, a lower priority number indicating high priority, for example. The rules engine 206 may also include a rules engine interception component 316. The rules engine interception component 316 may intercept data transmissions from the ABLL 308, ADAL 310, FSBLL 312, and FSDAL 314 prior to, during or after the execution of actions through the auxiliary layers (ABLL 308 and ADAL 310).

The rules engine interception component 316 may also access data being stored in the database 202 through the file save layers (FSBLL 312 and FSDAL 314). Upon intercepting such transmissions, the rules engine interception component 316 may process the data or model instances associated with such transmissions and write corresponding information (e.g. event entries) to the event queue 318. For example, if a particular patient file has been updated through the file save layers, the rules engine interception component 316 may write data (e.g. an event entry) to the event queue 318 indicating that the particular file was updated as well as the time at which it was updated. After writing a new event entry to the event queue 318, the rules engine interception component 316 may allow the data being processed through the auxiliary and file save layers to ‘pass through’ as though it had not been intercepted such that the auxiliary and file save layers may continue to execute actions and save data to the database 202.

In some embodiments, the event queue 318 includes a table of data or event entries. An event entry includes information about certain activities and data that has been intercepted by the rules engine interception component 316. An event entry activates the execution of certain rules by the rules engine 206 when the rules engine 206 polls the event queue 318 for event entries. The rules engine 206 polls the event queue 318 on a “first in first out” basis in some examples. According to some embodiments, an event entry may consist of data stored in the event queue 318 related to the creation, modification or deletion of files in the database 202, or the execution of actions that have taken place through the auxiliary layers.

As an illustrative example, if an email message is sent through the Auxiliary APIs 302, the rules engine interception component 316 may intercept such email message as it is processed through the ABLL 308 and add an event entry to the table of data that comprises the event queue 318 indicating that a particular email has been sent as well as the type of email (for example, a ‘new patient notification’ email), email recipient and time at which the email was sent. The rules engine 206 may be activated with an new event entry is added to the event queue 318. The rules engine 206 may also periodically poll the event queue 318 and, as it discovers event entries within event queue 318, initiate the execution of rules. Accordingly, the rules engine 206 polls the event queue 318 on a scheduled basis in order to initiate the execution of rules on a set schedule. In this way the rules may be run asynchronously from updates to the event queue 318 (e.g. by data modifications from a user device 102). In some embodiments event entries may be added to the event queue 318 on a scheduled basis in order to initiate the execution of rules on a set schedule. After the rules engine 206 finds an event entry in the event queue 318 and executes a given rule, the event entry may be removed from the event queue 318.

In an aspect, the rules engine 206 may be responsible for processing and executing rules when an event entry is found in the event queue 318. The rules engine 206 may be comprised of business logic for rule structure and processing, as well as the ability to alter data in the database 202 as example actions of rules. A few illustrative examples of data that may be altered in the database 202 by the rules engine 206 include changing fields in a patient file, creating new patient files, changing file properties (such as the file's owner), adding, removing and modifying sub-entities (such as follow-up actions to be taken on a file that are, in some embodiments, recorded in the file itself), adding, modifying, and updating manual tasks. Other example functions of workflow robot 200 by rule may be taken in connection with a file, such as adding and modifying alert configurations on a file (e.g. specifying when and which alerts or notifications should be sent when a file or type of file is modified).

In an aspect, the workflow robot 200 may include a workflow designer interface 212 that interacts with the rules engine 110. Administrator device 104 uses workflow designer interface 214 to configure rules to be processed by the rules engine 206 to automate actions of the workflow robot 200. The workflow designer interface 214 may also allow administrator device 104 to define, manage and view activity logs related to the execution of rules that have been executed by workflow robot 200. According to some embodiments, the workflow designer interface 214 has an expression editor so that an administrator device 104 can create or edit rules through inputting a particular syntax designating the conditions, logic and actions to be taken by the rules engine 206 for the rule being created or edited. In another embodiment, rules may be created by administrator device 104 using a graphical drag-and-drop interface of the workflow designer interface 212. Graphical elements represent objects (such as files, fields, tasks and sub-entities, for example) and operands (such as ‘greater than’, ‘equal to’, ‘temporally before’, etc.) which may be dragged from one panel in the graphical drag-and-drop interface to another panel in the drag-and-drop interface in order to form a logical expression involving conditions, logic and actions to be taken for the rule being created or edited. According to some embodiments, when a rule is created through the workflow designer interface 212, the rule may be precompiled into machine-readable code to enable efficient execution of rules by workflow robot 200 at runtime. As noted, rules engine 206 can be part of workflow robot 200 and can execute rules to automate actions of the workflow robot 200.

As an illustrative example, administrator device 104 creates a rule using workflow designer interface 214. A rule has different states (e.g. start state, intermediate state, end state). These states are transitioned between (e.g. by traversing linkages) by the workflow robot 200. The states have different triggers and conditions that, for example, modify the characteristics being intercepted by the rule engine interception component 316, dependent on the current state of the rule. Each rule may be a series of linked states, stored as one or more linked data structures on the database 202. Each state, for example, may be representative of (1) which events should the workflow robot 200 be paying attention to, (2) what actions is the workflow robot 200 supposed to take, (3) where various electronic files exist on database 202 or other data storage, and (4) what happens after the action is completed.

An improvement that is provided by having rules with different states is that intermediate states and their corresponding actions and triggers can be accounted for. For example, healthcare workflows often include various different actions to be take place based on contextual features, and the state of workflows changes based on received information. In a specific, non-limiting example, an incoming patient, as new information is received related to condition, intake, treatment, administration of drugs, etc., may have modifications of a workflow that are context dependent on the new information. While a same workflow may be invoked, different states may be used to capture this context dependence and shift actions and triggers accordingly. Transitions between states can be identified such that the workflow robot 200 is able to advance rules from one state to another, as events are processed. State management can be helpful in correct identification of potential conflicts between actions, the current states of each rule may govern whether a potential conflict arises, and whether such conflict needs to be resolved for the proper functioning of the workflow robot 200.

A graphical representation of a rule has graphical elements representing different state nodes (e.g. a start state node and an end state node) for the different states of the rule. Rule state connectors connect the state nodes of the graphical representation of the rule. An example rule specifies that when a new patient file is created, an email notification is sent to a particular healthcare practitioner, Dr. Smith. In this case, administrator device 104 uses graphical elements of the workflow designer interface 214 to define different state nodes for the rule. The administrator device 104 uses graphical elements of the workflow designer interface 214 to drag a rule state connector from an entities panel to a rule logic panel in the workflow designer interface 214 to connect the state nodes of the rule. A rule state connector may be represented as an arrow connecting a start state node (e.g. represented as a polygon shape graphical element) to an end state node. The administrator device 104 may then edit the rule state connector to specify a condition or trigger to be evaluated by workflow robot 200 upon execution of the rule state connector. An example condition is that a new file has been created. Further, the administrator device 104 may specify an action to be performed if the condition returns true. An example action is generating and sending an email to an electronic address linked to Dr. Smith. In some embodiments of the workflow designer interface 214, the administrator device 104 edits the condition of the rule state connector by dragging the following labels from one panel of the workflow designer interface 214 to another panel in the following order: “FILE”, “IS CREATED”. Similarly, administrator device 104 edits the action of the rule state connector by dragging the following labels from one panel of the workflow designer interface 214 to another panel in the following order: “SEND EMAIL TO”, “DR. SMITH”. According to some embodiments, the workflow designer interface 214 may interact with data access layers (auxiliary DAL 310, file save DAL 314) of the workflow robot 200 in order to pull (dependent) data from the database 202 as options are selected in the workflow designer interface 214. For example, when an administrator device 104 selects “SEND EMAIL TO”, the workflow designer interface 214 may prepopulate one panel with potential email groups and recipients (such as “DR. SMITH”) that may be dragged to the other panel of the Workflow designer interface 214 to define conditions and actions for the rule.

In some embodiments, a rule may be comprised of conditions (which are also referred to as triggers) that are expressions evaluated by the rules engine 206 to determine whether a particular rule should be executed or whether a particular state of a rule should be entered. A condition is evaluated to trigger execution of an action of the rule. Components of a condition that are evaluated against certain criteria may include criteria based on data changes such as the modification of file properties (such as state, confidential status, etc.), the modification of file fields, the creation or modification of sub-entities such as actions or comments on a particular file, the creation of new files, and the modification of file ownership such as changes in the users or groups given read or write access to a file or sub-entity, and so on. Components of a condition of a rule may also include inactivity or time-originating conditions such as the idleness or inactivity of a file or a particular property thereof, or the evaluation of the current date and time against a time field in a file. For example, a rule's condition might be that a file is inactive for more than 30 days to execute an action of the rule to send a notification to a medical professional. In such a case, actions for rules with this condition would not be executed on files that have been modified or otherwise active less than 30 days prior to the rules execution.

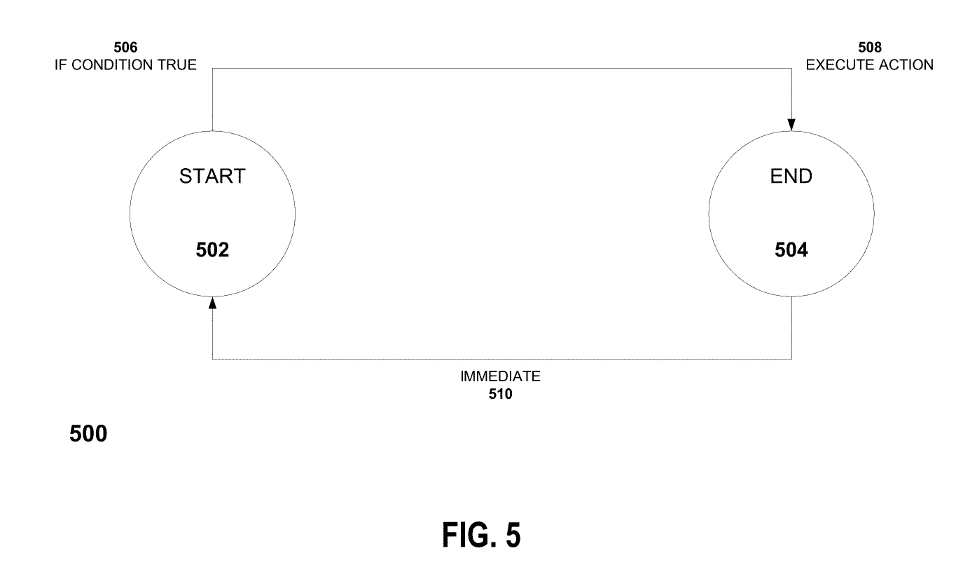

FIG. 5 illustrates an example rule 500 based on a “if this then that” expression. An example graphical representation of the rule 500 has a start state node 502 and an end state node 504. Rule state connectors connect the start state node 502 to the end state node 504. The rule 500 has a start state node 502 with a condition 506 to be evaluated and a resulting action 508 to be taken. The rule 500 has an end state node 504 with an action 510 to be taken. The example action is to immediately move from the end state node 504 back to the start state node 502. The rules engine 206 begins at the start state node 502, evaluates the condition 506 and, if necessary based on the result of such evaluation, executes a particular action 508 defined in the rule. Upon execution of the action, the rule 500 enters the end state node 504 whereupon it immediate returns to the start state node 502 by the action 510. While executing the rule 500, results may be returned by the rules engine 206 or actions may be triggered, including results with information related to whether the action 508 was executed successfully and any values returned by the action 508. These results may be stored in an activity log table in the database 202. In some embodiments, the logic of a rule may involve the many disparate components of the workflow robot 200. As an illustrative example, if a “feedback” file is created involving a patient's complaint concerning a safety hazard, the rule 500 logic may cause the rules engine 206 (or more the workflow robot 200) to create a “Risk” file (outlining potential risks to be addressed in a healthcare environment) and a “Claims” file (outlining potential legal risks) automatically.

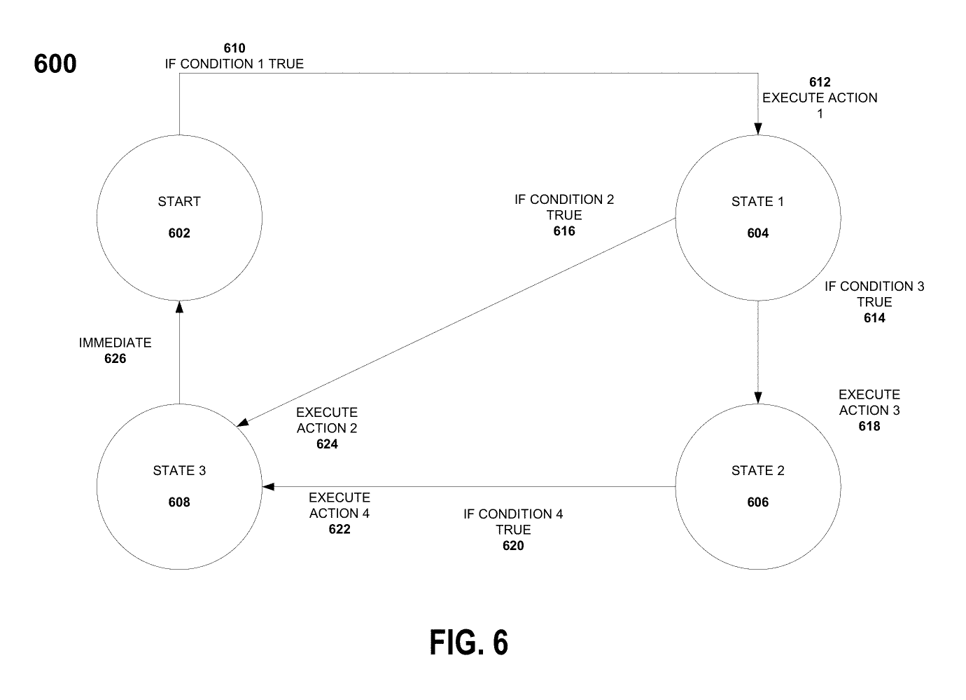

FIG. 6 illustrates another example rule 600 based on a more complex machine state expression. This example rule 600 defines various states such as start state node 602, state 1 node 604, state 2 node 606, and state 3 node 608. The state nodes are connected by rule state connectors. The states of the rule 600 in relation to a file or context may be saved in a Rule State Table in the database 202. In some embodiments, the Rule State Table of the database 202 is a specially configured data structure having linkages and relationships defined which allow for the traversal and transition between different states of the rule 600. These linkages may include, for example, memory location pointers, corresponding unique/foreign key references to database table records, and the linkages may, in some cases, cause the providing of one or more values as parameters between state transitions.

The rules engine 206 will evaluate the current state of an object linked to the rule 600 when evaluating conditions of the rule 600. The states defined the rule 600 indicates what conditions are evaluated and what actions are executed. Each state may have various conditions and associated actions that, in turn, link to new state nodes through rule state connectors. Conditions related the current state of a file or object being modified or processed through the rule 600 will be checked and executed as the complex machine state rule 600 is executed.

In the example depicted in FIG. 6, there are various conditions, actions, states and rule state connectors. The rule 600 starts execution at the start state node 602 and proceeds through the rule state connector and evaluation of the condition 1 610 before executing the action 1 612 and then proceeding to state 1 node 604. After entering state 1 node 604 the rule 600 evaluates two (mutually exclusive) conditions (e.g. condition 3 614, condition 2 616). At state 1 node 604, the rule 600 evaluates condition 3 614, and if returns true, executes an action 618 and proceeds to state 2 node 606. When at state 1 node 604, the rule 600 also evaluates condition 2 616, and if returns true, executes action 2 624 and proceeds to state 3 node 606. When at state 2 node 606, the rule 600 evaluates condition 4 620, and if returns true, executes an action 622 and proceeds to state 3 node 608. When the rule 600 is at state 3 node 603, the rule 600 would traverse immediately to the start state node 602 (by executing the immediate action 626).

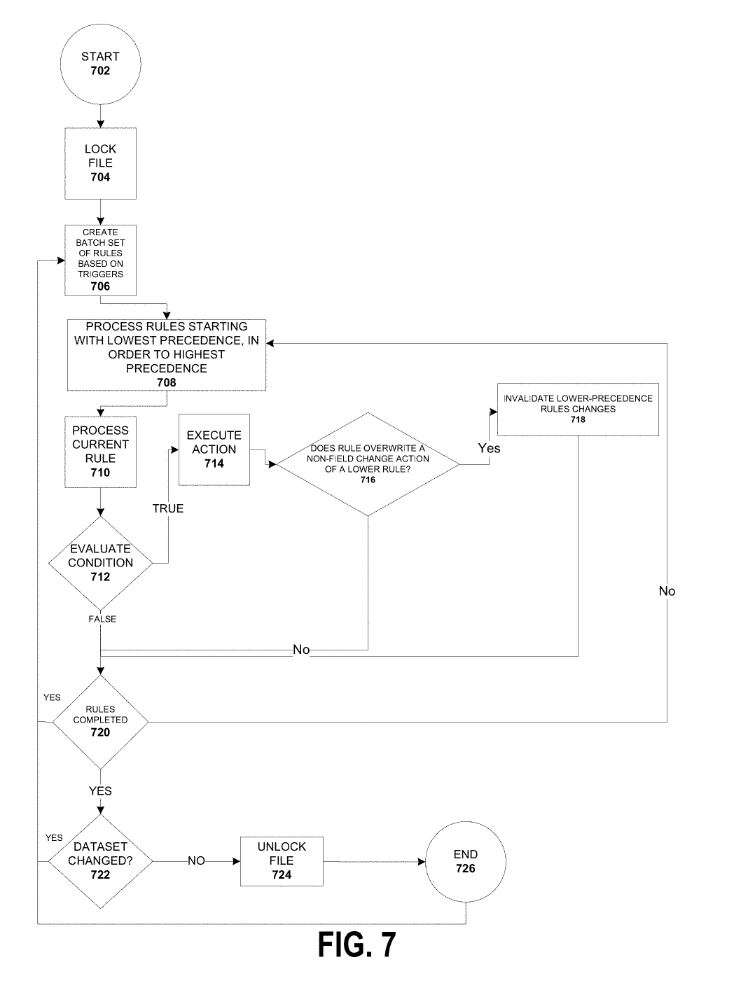

FIG. 7 illustrates an example process of the rules engine 206 for execution of a set of rules as a result of an event entry in the event queue 318. The process or portions of the process may be implemented by workflow robot 200 in some embodiments. The workflow robot may include rules engine 206 or integrate with rules engine 206.

At 702, the rules engine 206 polls the event queue 318, and identifies a particular event entry associated with at least one file in the database 202 (or an external database 208). The rules engine 206 (or workflow robot 200) begins processing the file(s). At 704, the rules engine 206 locks the file(s) associated with the event entry. In some embodiments, locking the file prohibits modification of the file by another user device 102 or administrator device 104 while the rules engine 206 carries out processing on the file(s).

At step 706, the rules engine 206 creates or identifies a batch set of rules that are relevant to the file(s) being processed and transmits the batch for processing. At step 708, the rules engine 206 orders the batch of rules from lowest priority to highest priority (as an example priority sequence) and begins executing the rule of lowest priority (current rule). In executing rules in this order, the rules engine 206 may ensure that rules of higher priority will take precedence by ‘overwriting’ the results of actions of rules of lower priority or, in other embodiments, ‘un-doing’ the changes made to the dataset by actions of rules of lower priority.

At step 710 the rules engine 206 begins to process the current rule in the batch (based on the priority sequence for the batch of rules). The rules engine 206 evaluates the condition of the rule (and of any state defined by the rule) at step 712. If the condition evaluates to TRUE, at step 714 the rules engine 206 begins to execute the action associated with the rule (and of any state defined by the rule). If the condition evaluates to FALSE, the rules engine 206 proceeds to the next rule for processing at 710.

After executing the action of the current rule (at 714), the rules engine 206 may perform various functions related to resolving conflicts resulting from the execution of the batch set of rules using the priority sequence. In some embodiments, rules in a batch may be executed on an iterative dataset and changes made by a previously executed rule modify the dataset used in processing a later executed rule. In other embodiments all rules in a batch may be executed on the original data set. In some embodiments, at 716, the rules engine 206 determines whether the currently executing rule overwrites a non-field change action of a rule of lower priority according to the priority sequence. If the current rule (and execution of its action) does overwrite a non-field change action of a rule of lower priority, at 718, the rules engine 206 may invalidate, prevent execution of the action, or ‘undo’, ‘rewind’, or ‘revert’ the changes made by the rule of lower priority. In another embodiment, the rules engine 206 may only overwrite the portion of the changes made by the rule of lower priority that conflict with the changes made by the rule of higher priority.

In another embodiment, where a rule specifies that a file or sub-entity need be created or deleted, the rules engine 206 may add creation and deletion actions to a queue or may flag files for creation or deletion before executing such action. The rules engine 206 may only execute such action after the entire batch of rules have processed in order to ensure that there are no conflicts with rules of higher priority. According to some embodiments, the rules engine 206 may save data to the activity log table in the database 202 after a rule has been executed indicating that the rule has been executed, as well as the time and status of its execution.

At step 720 the rules engine 206 determines whether the batch of rules has completed processing. If it has not, the rules engine 206 returns to 708 to continue to iterate through rules in the batch based on the priority sequence (order of lower priority to higher priority). If the batch of rules has completed processing, the rules engine 206 proceeds to 722 and polls the dataset associated with the event entry (in the event queue 318) to determine whether the dataset has changed and, if so, may return to 702 and iterate through the batch of rules again until execution of the batch of rules no longer results in changes to the dataset. At 724, the rules engine 206 unlocks the file that was locked at 704, and completing the process at 726. According to some embodiments, after an event entry has been detected or identified by the rules engine 206 polling the event queue 318, the event entry may be removed from the event queue 318. In some embodiments, addition of a new event entry to the event queue 318 may activate the workflow robot 200 (or rules engine 206) to poll the event queue for event entries and activate the process.

In some cases, rule 600 is configured to revert back to a start state 602 when the various states of rule 600 are completed (e.g. at 726).

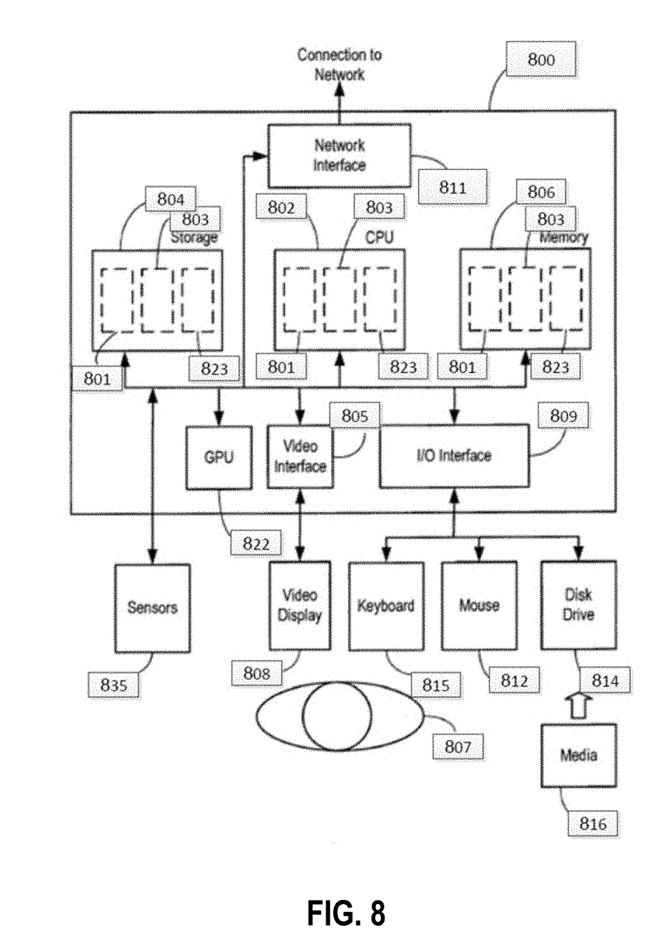

The present system and method may be practiced in various embodiments. A suitably configured computer device, and associated communications networks, devices, software and firmware may provide a platform for enabling one or more embodiments as described above. By way of example, FIG. 8 shows a computer device 800 that may implement aspects of embodiments described herein. The computer device 800 includes a central processing unit (“CPU”) 802 connected to a storage unit 804 and to a random access memory 806. The CPU 802 may process an operating system 801, application program 803, and data 823. The operating system 804, application program 803, and data 823 may be stored in storage unit 804 and loaded into memory 806, as may be required. Computer device 800 may further include a graphics processing unit (GPU) 822 which is operatively connected to CPU 802 and to memory 806 to offload intensive image processing calculations from CPU 802 and run these calculations in parallel with CPU 802. An operator 807 such as a user device 102 or administrator device 104 may interact with the computer device 800 using a video display 808 connected by a video interface 805, and various input/output devices such as a keyboard 815, mouse 812, and disk drive or solid state drive 814 connected by an I/O interface 809. The mouse 812 may be configured to control movement of a cursor in the video display 808, and to operate various graphical user interface (GUI) controls appearing in the video display 808 with a mouse button. The disk drive or solid state drive 814 may be configured to accept computer readable media 816. The computer device 800 may form part of a network via a network interface 811, allowing the computer device 800 to communicate with other suitably configured data processing systems (not shown). One or more different types of sensors 835 may be used to receive input from various sources. The application program 803 may be a target application in some example embodiments, or may be a client application program 803 that connects to a target application. As another example, the application program 803 may be a client interface program such as the workflow designer interface 212 or form engine 204 configured to control display 808 to provide a visual representation of data in the workflow robot 200 and receive feedback or confirmation (via I/O interface 809) regarding the the operator's interaction with the client interface.

The following provides further details of the components referenced in the description and drawings.

The Workflow robot 200 assists users for different use cases. Examples include: (1) A user (who works on files) wants to know: (a) What files do I need to work on? (b) What work do I need to do on them? (2) A administrator (who managers users who work on files) wants to know: (a) What her users are working on? (b) What work is overdue?

The Workflow robot 200 encompasses multiple components and the interaction between those components to meet the requirements of the system. A example architecture diagram is provided in FIG. 4.

The architecture of the system consists of a few example functional areas:
Form designer 216 and workflow designer 214 for configuring form and workflow rules using an administrator device 104
Form engine 204 and client-side rendering component (on user device 102) responsible for form rules
Rules Engine 206 incorporating a message or events queue 318 for workflow rules
an Alert Engine 208 to generate alerts in response to actions of rules
web service APIs and BLL/DAL facilitating requests.
Rules Engine Interception Component 316 for monitoring activities and adding event entries to the event queue 318 to activate the workflow robot 200

The Form Rendering Engine 204 interacts with a client-side component (on user device 102) that renders forms for the user in both submission and management modes across all units. The component's role within the workflow robot 200 is to interpret and execute form rules that are configured by user device 102 or administrator device 104 when rendering a form. This incorporates different functionality such as visibility of sections and fields controlled by expressions, as well as requirements to handle rules dealing with synchronous, form-specific logic in a configured workflow.

Form Engine APIs 304 are a collection of Server-Side APIs that support the client-side form rendering component, including providing form definitions, constraints and rules, picklist values, and so on, in the appropriate form. This component is responsible for interpreting defined form rules in the form content XML, parsing them, and sending them to the client in the desired format.

The File Save APIs 306 are responsible for facilitative save and update requests from the client side. The File Save APIs 306 interface with File Save BLL/DAL 312/314 to process and save file data to database 202.

Auxiliary APIs 302 are a collection of APIs that can be called directly from the Form Rendering 204 client side component to perform specific actions that result from a client interaction or execution of a form rule (e.g. sending a notification or email). Auxiliary APIs 302 interact with underlying auxiliary BLL/DAL 308/310 to process the request. Auxiliary APIs 302 may be called without saving the file in some circumstances.

Auxiliary BLL/DAL 308/310 layers process auxiliary form requests. Resulting data changes are analyzed by Rules Engine Interception Component 316 before data is saved, and may produce a trigger for the Rules Engine 206 and add event entries to the event queue 318.

File Save BLL/DAL 312/314 layers process auxiliary form requests. Resulting data changes will be analyzed by Rules Engine Interception Component 316 before data is saved, and may produce a trigger for the Rules Engine 206 and add event entries to the event queue 318.

The Rules Engine Interception Component 316 is a component that is responsible for handling interaction with the Rules Engine 206. In some embodiments, the Rules Engine Interception Component 316 is a server-side component as part of the workflow robot 200. The Rules Engine Interception Component 316 has business logic to make decisions at file save as to whether an event entry needs to be added to the event queue 318 for the rules engine 206. The event entry, for example, may require downstream actions for handling logic for autosave and data persistence, bundling dataset information and deltas, and so on. In some scenarios, the rules engine interception component 316 might not prevent a file save and data can still pass through to the database 202 for a dataset save.

The workflow robot 200 includes an event queue 318 for event entries that can be run asynchronously from the user's session. The content of the event entries in the event queue 318 may include additional information to assist the rules engine 206. New event entries in the event queue 318 send a signal to activate the rules engine 206.

The workflow robot 200 includes or integrates with a rule engine 206 component responsible for processing and executing rules when a new event entry for a file is received on the event queue 318. The rule engine 206 encompasses business logic for rule structure and processing, the ability to alter dataset for the file, automate the creation of new sub-entities, task, follow-ups, notifications, etc. and changing file properties.

The alert engine 208 facilitates the generating of alerts and notifications based on defined alert or schedule expressions and actions of rules.

The form designer 216 interacts with (or resides on) an administrator device 104. The form designer 214 configures form rules including but not limited to existing expressions on form components.

The workflow designer 214 interacts with (or resides on) an administrator device 104 that can serve as a hub for administrators to configure workflow rules that will be processed by the rule engine 206. The Workflow Designer 214 enables users to define, manage, and view activity logs on rules that have been processed on files.

The example division of rule types between form rules and workflow rules satisfies different functional requirements, with a technical separation of rule sets that leverages form and workflow infrastructure, and handling of rules for different contexts that together can form the workflow processes.

The form engine 204 is responsible for processing rules that affect the behaviour of a form during a current user session. Form rules can be executed in a synchronous manner and affect interaction by user device 102 with the current form itself, not the persisted data on a file. Example of form rules include to control field visibility, enabling or disabling certain tabs in the form, etc. In addition, a form rule could trigger an action to call an auxiliary API 302 at the server to perform a specific task.

The rules engine 206 is responsible for processing rules that are based on dataset changes when a file is saved or upon occurrence of other events (that result in a new event entry on the event queue 318). Workflow rules are executed in an asynchronous manner, separate from the user session working with the file, and work with the persisted data set. These rules could result in actions such as changing file properties, field value, or creating follow-ups or tasks.

The table below contrasts the characteristics and responsibilities of the Form engine 204 and the rules engine 206.

| Characteristic | Form Engine | Rules Engine |
|---|---|---|
| Rule Types | Form Rules | Workflow Rules |
| Mode of | Synchronous (Blocking) | Asynchronous |
| Execution | | |
| Configuration | Form Designer | Workflow Designer |
| Control of | Blocking - Can prevent | Cannot prevent action |
| User Action | Action | |
| Dataset | Temporary - Client-side | Persisted (real database) |
| Primary | Client Side | Server Side |
| Processing | | |
| Locking | File Locked in Session | Will Lock File |
| Trigger | User/Control Interaction, | Time-based, File Save |
| Types | Form Load | |
| Conditions | File (Fields, Sub-objects, | File (fields, sub-objects, |
| | properties), System & User | properties), system and |
| | variables, form properties | user variables, role, |
| | in session (tab selected, | scope, location, etc. |
| | etc.) | |
| Actions/ | In-session form rendering | Change fields |
| Outputs | changes (eg. Visibility, | Change properties (eg. |
| | tab switch, etc.) | Change owner) |
| | Call-Out for external API | Add/Remove/Modify sub- |
| | (eg. Send a notification) | objects (eg. Followup) |
| | | Send notifications |
| | | Add/Modify/Update Tasks |
| | | Add/Modify Alert |
| | | configuration |
| | | Automate Send To |

In some embodiments, new event entries in the event queue 318 activate the rules engine 206 to iterate workflow rules. Events not really part of a workflow rule itself but trigger execution of the workflow rule. Example events include a file save, or time scheduled event. Events start the rule engine 206 processing a batch of rules on particular file. In some embodiments, events may need to include more defined actions than just file save. Certain groups of rules may have triggers to only execute if in a specific role, or location, etc. rather than include these within the condition explicitly. A binary executable encapsulation engine may be provided that is configured to activate the rules engine to iterate the set of rules to identify a complete set of actions and triggers indicative of the current states of all rules; and encapsulate a point-in-time binary executable representative of the complete set of actions and triggers, the point-in-time binary executable used for the activation of the workflow robot to execute the actions in response to events.

These binaries can be generated overnight or over other periods of low processing load in an effort to more effectively manage or utilize finite computing resources. Similarly, the binaries may be executed sequentially overnight in accordance with an events queue to more effectively manage or utilize finite computing resources.

In some embodiments, a workflow rule can be made up conditions and actions.

A condition is an expression that can be evaluated to determine if the rule (or an action of the rule) should execute. Components that make up the expression for a condition include automated or system triggers (originating from data change). Examples include:
File Properties are modified (including state, confidential, status, etc. anything that's not a field) (ENTITY—File/Field)
Specific field is modified on a form (ENTITY—File/Field)
Sub-entity/sub-table of a file is created (ENTITY—Action Item)
Sub-entity/sub-table of a file is created (ENTITY—Comment)
A new file in the system is created (ENTITY—FILE)
Specific field is modified on a Sub-Entity of the form (ENTITY—Comment save, Expression Logic can include reference to that FIELD)
A user RELATIONSHIP to a file changes (Watcher, Granted Access, Committee member, etc.) (ENTITY—FILE, RELATIONSHIP, USER)
A user RELATIONSHIP to a sub-object/sub-table of a file changes (Subject & Reviewer Pairs) (ENTITY—FILE, RELATIONSHIP, USER, SUB-OBJECT)

Components that make up the expression for a condition include inactivity or time originating triggers. Examples include:
File Idle/Inactivity (ENTITY—File)
A certain PROPERTY of a file has not changed in a defined amount of time (eg. File State) (ENTITY—FILE)
A certain TIME FIELD in a file (e.g. Deadline) is past current date/time (eg. Review Deadline) (ENTITY—FILE)

Components that make up the expression for a condition include consolidated triggers. Examples include:
File properties
File Fields
File sub-object fields
File sub-object counts
Nested sub-object counts
Creation/Deletion/Modifications of sub-entity or nested sub-entity (Entity-File Relationship)
User-File Relationship Changes (Watcher, Owner, PR member etc.)
User-Sub-object Relationship Changes (Subject & Reviewer concept in PR)
Inactivity
Aggregate Counts or Filtering (similar to reporting)

An action or result of a rule executed if the condition of the rule is met (returns true). For execution of the workflow rule in the file, a defined action can be taken. Actions may include, but are not limited to the following:
Change fields
Change properties (eg. Change owner)
Add/Remove/Modify sub-objects (e.g. Followup)
Send notifications
Add/Modify/Update Tasks
Add/Modify Alert configuration
Automate Send To

Rules engine 206 manages rules in database 202. A rule can be defined in the healthcare workflow system 100 in different ways.

For example, there may be “If This Then That” rules. An example rule has one condition and one result. Each time the rules engine is triggered, the single condition is evaluated, and single result can occur. See FIG. 5, for example.

As another example, there may be complex state machine rules: Rules that involve defined states can also be supported by healthcare workflow system 100. The rule has multiple states. The state of the rule in relation to a file or context is saved in a rule state table of database 202. Each state could have many actions, linking to new states. Only conditions that branch from the current state that the file is on for that rule will be checked and executed when the rule engine 206 (or workflow robot 200) processes the rule. See FIG. 6, for example.

Rules engine 206 processes rules for automating actions of workflow robot 200. In some embodiments, when the rules engine 206 is activated for a specific file, all rules whose triggers apply will be executed together in a batch.

In some embodiments, workflow robot 200 locks the file at the start of processing the batch of rules. Other users cannot access the file while it is held by rules engine 206.

Due to possibilities of conflicting rules, an order of precedence or rank may need to be implemented. This may be referred to as a priority order for rules.

All rules can be given a rank (e.g. 1 being the highest precedence), meaning that that rule's action takes precedence over an action that a competing rule may invoke. For example, one rule may be if severity is high, then set owner to Jian, and a second rule may be if location is Site 1, set owner to Alex. In this case, if the first rule is of higher precedence, even though the file is Site 1, perhaps the client wants all high severity files to go to Jian regardless of location. This could be configured using priority orders that are assigned to rules. Different batches can have different priority orders for the rules. During programmatic traversal and transitioning between rules, conflicting rules may be resolved by only executing higher priority rules/actions.

As another example, if rules are run LOW->HIGH precedence, then a HIGH action will overwrite LOW actions. If HIGH and LOW rules conflict only on a single field, then the whole LOW rule may be invalidated or narrowed so that the LOW rule action is only in reference to that single field.

In some embodiments, all rules executed make condition decisions based off the iterative dataset as rules complete, not the original dataset. In some embodiments, all rules executed make condition decisions based off the original dataset. The rule engine 206 may be configured to perform a first validation run to identify any conflicts when an event is sensed, and to resolve the conflicts by prioritizing and ranking the actions prior to execution based on the sensed event.

Rule engine 206 may “re-run” iterations if changes to the dataset are made on the first pass, as rules might chain (e.g. dependency relationships with other rules) based on modified values. After Rule engine 206 has completed working on the file by executing rules, changes are written the database 202, all external actions are taken, and the file lock is released. Rule engine 206 event logs can also be written to track automated workflow changes that occurred. FIG. 7 depicts an example process.

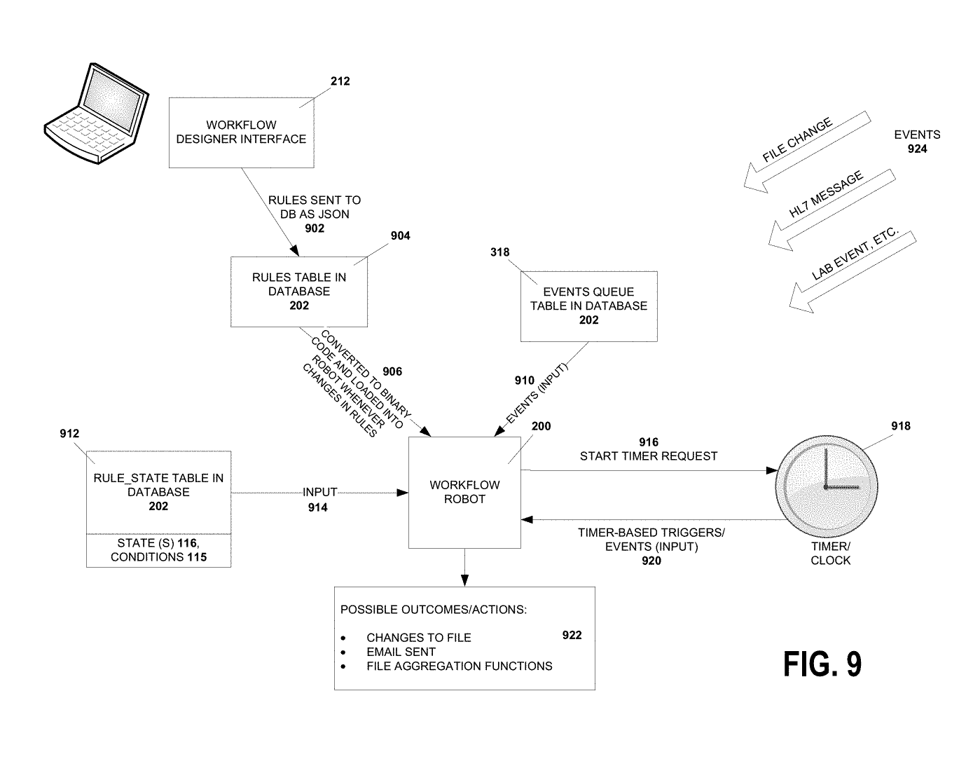

FIG. 9 is another diagram of a workflow robot 200 with data flows for interactions with workflow designer interface 212 and the tables in the database 202. The workflow robot 200 may include or integrate with the rules engine 206. In an aspect, when an administrator device 104 saves a new rule using workflow designer interface 212, at 902, the new rule may be serialized and saved in the database 202 in a rules table 904 (or Model Table) as JSON, XML, a text file or some other form of serialized object data.

At 906, when changes are made to the rules table 904 in database 202, the rules may be re-converted into binary in some embodiments. In another aspect, when rules engine 206 (or workflow robot 200) begins execution of a rule, at 914, the rules engine 206 may save the current state of execution of the rule as input to the rule state table 912 in the database 202. In some embodiments, the rules engine 206 may periodically check the rule state table 912 for the current state of execution of a rule and proceed to the next State 116 of such rule if a given Condition 115 has been satisfied. The events queue 318 in the database 202 provides event entries to workflow robot 200 for processing using the rules managed by rules engine 206. Different events 924 correspond to new event entries in the events queue 318. For example, events may include a file change (e.g. as detected by an interceptor component 316), an HL7 message, a lab event, and so on. New event entries in the events queue 318 generate signals to activate the workflow robot 200 at 910.

Activation of the robot, for example, may include the generation of one or more binaries that are used to execute actions in accordance with the rules (e.g. as prioritized by priority rankings) based on sensed events from extracted from the events queue 318. In some embodiments, to speed execution or to reduce processing burden during times of increased processing load, the binaries are pre-generated (e.g. by a binary encapsulation engine) ahead of receiving the events. The compiled binaries can be encapsulated, for example, in the form of a dynamic-link library (DLL), among others. In some embodiments, an extended markup language (XML) file is generated indicative of the rules and their execution parameters at a particular point in time, the XML file being usable to dynamically generate binaries.

In some embodiments, as state transitions occur, binaries are re-created and regenerated to reflect state changes. In such embodiments, to improve processing speed and to reduce the complexity of the binaries, states are consolidated and compressed such that only a current reflection of the triggers and actions of the current state of each rule is provided in the XML or compiled binaries. In other words, the workflow robot 200 collapses the rules into executable binaries during compilation, the binaries executable in response to received events. In some embodiments, workflow robot 200 selectively regenerates the executable binaries only when a state transition is detected in at least one of the rules (e.g. does not regenerate the executable binaries if a state transition does not occur, since the executable binaries are still valid). The generation and regeneration of executable binaries may be a processing/resource intensive process where a large number of rules are being evaluated, especially where there are multiple conflicts and dependencies that require resolution by, for example, determining which actions and rules have priority over each other by way of evaluating field values associated with priority fields of the various objects.

In some embodiments, at 916, the rules engine 206 (or workflow robot 200) may create timer requests by transmitting signals to a timer 918 that receives data. At 920, the timer 918 transmits signals back to the rules engine 206 upon completion of countdowns. The signals activate the workflow robot 200 to process the time-based events. For example, if a rule requires 10 minutes to elapse prior to progressing to the next state of the rule, at 916 the rules engine 206 transmits a signal to the timer 918, requesting a notification in 10 minutes time. Timer 918 begins a 10-minute countdown and at 920 transmits a signal back to the rules engine 206 after 10 minutes has elapsed. The rules engine 206 could then proceed to the next state of the particular rule. According to some embodiments the timer 918 may handle multiple concurrent timer requests and countdowns. The workflow robot 200 can trigger different outcomes at 922 by evaluating conditions of rules and executing actions of the rules.

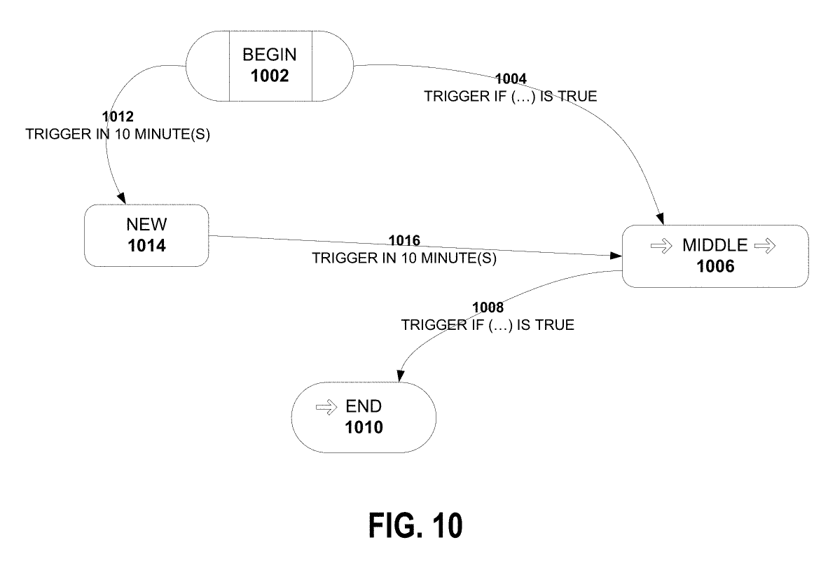

FIG. 10 is an example depiction of a graphical interface of the workflow designer interface 214 to create or modify rules. According to some embodiments, each rule may have states such as a start state, an end state and a series of one or more middle (intermediate) states. As a rules execution progresses between states, workflow robot 200 (or rules engine 206) evaluates conditions of the state and executes actions. In the workflow designer interface 212, states may be connected through rule state connectors, which cause the rules engine 206 to evaluate predefined logical expressions (conditions) prior to progressing to a new state within a rule. The state of a rule may be represented by nodes while the rule state connectors may be represented by arrows within the workflow designer interface 214. As an example, in FIG. 10, the rule depicted would begin execution at start state node 1002 by traversing two logical paths with conditions 1004, 1012.

On one such logical path, the rule would evaluate whether a particular condition 1004 (“trigger if ( . . . ) is true”) returns true and proceed to the middle state node 1006 if so. Simultaneously, for the other condition 1012, the rule would begin a timer routine by transmitting a signal to the timer 918 that counts down from 10 minutes. After the Timer 918 notifies the rules engine 206 that the countdown has completed, the rules engine 206 would create a new object at the “new” state node 1014. After creating the new object, the rules engine 206 evaluates a condition 1016 to begin another timer routine by transmitting a signal to the timer 918 that counts down from 10 minutes. The rule proceeds to the middle state node 1006. Rules engine 206 evaluates the condition 1008 of the middle state node 1006 to execute associated actions. Finally, after the middle state node 1006 actions have been executed, the rules engine 206 proceeds to the end state node 1010. The graphical interface of the workflow designer interface 214 to create or modify rules by dragging and dropping graphical elements for states, conditions, actions, and rule state connectors.

The workflow designer interface 214 is configured to provide an editor that diagrammatically provides interactive interface elements (e.g. bubbles representing states) that can be manipulated on an interface (e.g. by a non-technically oriented user) to indicate actions, triggers, and state transitions (e.g. state linkages). Field values may be populated for priority/rank of actions or rules. The workflow designer interface 214 may include an interactive widget or tool that is used to finalize the rule set by causing the rules to be updated on database 202, causing an encapsulation of the rules into a stored data structure.

The bubbles, for example, may be “drag-able” or drop-able elements, and using an input device, such as a mouse cursor, a workflow designer may be able to interface with one or more interactive elements (e.g. a handle) that can be extended to indicate linkages between various bubbles, triggering both a graphical representation on a screen and also a backend generation of a linkage (e.g. memory location pointer) on a data structure. States having different priorities for their corresponding actions may be assigned a different color fill value and rendered accordingly to provide a visual representation. For example, higher priorities may be shown in a darker color, while lower priorities may be shown in a lighter color.

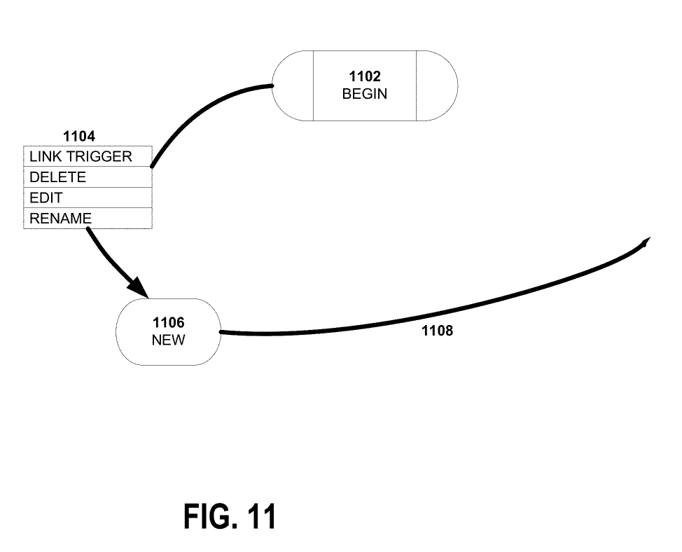

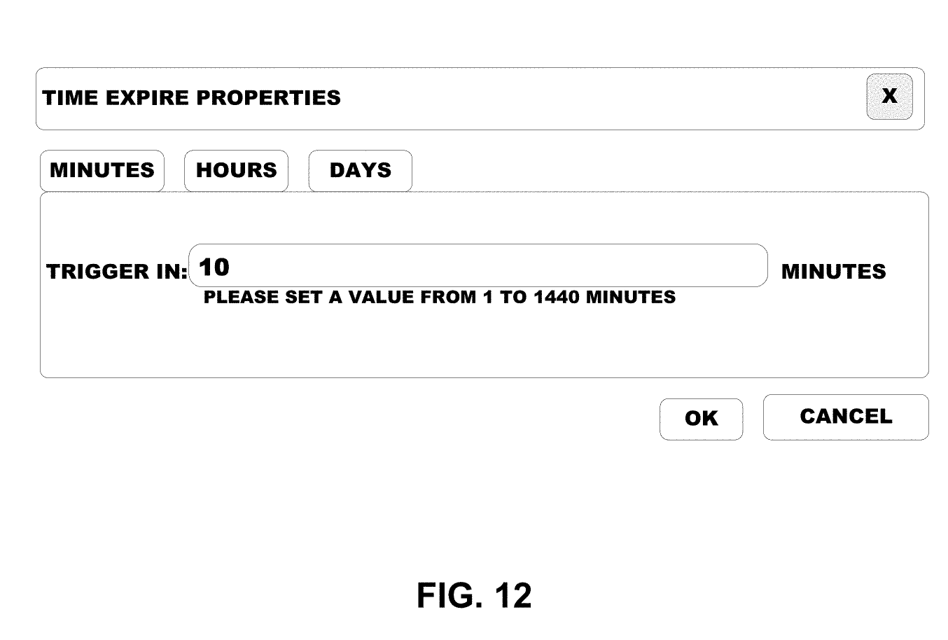

FIGS. 11 and 12 are example depictions of an aspect of the workflow designer interface 214 wherein an administrator device 104 may edit rule state connectors. For example, an administrator device 104 may activate (e.g. right-click with a mouse) an arrow for a condition 1104 of a rule state connector connecting a start state node 1102 of a rule to a new state node 1106. Upon activation of the condition 1104, the workflow designer interface 214 displays a contextual menu to delete, edit or rename the condition 1104 for the rule state connector. FIG. 12 depicts a rule state connector editor that allows an administrator device 104 to specify, for example, time expiry properties of a condition of a rule state connector signifying a delay to be executed prior to the execution of a later state of a rule. In some embodiments, other aspects of rule state connectors may be edited in the workflow designer interface 212 such as, for example, actions to be taken, objects associated with such actions, conditions to be evaluated on files and other objects and conditions to be evaluated on states of the workflow robot 200 or rules engine 206.

In an example workflow interface, a user is able to visually identify conflict resolution in the example workflow interface, at a given point in time (e.g. based on current states at the point in time), and when a sample event is intercepted by the workflow robot 200. The user may also be able to “step through” workflow implementation for a sample set of event data received at different points in time. The “step through” may include the provisioning of a “slider bar” widget that allows points in time to be traversed in both a forwards and a backwards direction. Actions that have been de-prioritized may be visually distinguished (e.g. by graying out), and state changes may be indicated by modification of visual elements (e.g. by highlighting those that have transitioned states), and a window portion may include a dynamically modified table depicting a summary of the actions taken by workflow robot 200, and downstream effects on other systems.

Workflow robot 200 includes different server integration components such as the rule engine interception component 316 (FIG. 4). The rule engine interception component 316 recognizes events and adds event entries to the event queue 318. Rule engine interception component 316 has server code for dataset interception and manages the queue for workflow robot 200. The rule engine interception component 316 has logic for autosave, and persistence interaction. The rule engine interception component 316 packages information relating to a detected event as an event entry to send to the event queue 318 (e.g. including dataset delta or difference).

Workflow robot 200 processes rules and rule sets in response to being activated when a new event entry is added to the queue. Workflow robot 200 takes appropriate actions as results of rule executions. Workflow robot 200 implements file locking for rule processing. Workflow robot 200 may also involve automatically: creating tasks as part of workflow implementation, creating follow-ups, changing data fields, changing file properties (e.g. owner), and so on.

Workflow robot 200 has a form engine 204 that interacts with a form designer interface 216 (client front-end) for administrator device 104. The form engine 204 also interacts with a form interface 210. User device 102 may have a form interface 210 to generate requirements for filtering or sorting a list of files a user has to work on. User device 102 may have an alert interface showing which files have alerts or notifications. User device 102 may have a client robot 220 showing tasks of a workflow for user, to implement aspects of the workflow robot 200 on the user device 102, and other functionality. There may be a management view for managers using user device 102, which may provide a list of volume-based alerts, for example.

Workflow robot 200 is a server-side service that is responsible for executing and processing rules which have been created by the administrator device 104 using the workflow designer interface 214. Workflow robot 200 takes actions based on these rules. Workflow robot 200 acts when an event happens that triggers the activation of workflow robot 200 (e.g. new event detected and a new event entry added to the event queue 318 which sends a signal to activate the workflow robot 200). Events happen at a particular time and corresponding event entries are added to the event queue 318. A signal activates the workflow robot 200 when event entries are recorded into the EVENTS_QUEUE table of the database 202 (e.g. event queue 318).

Workflow designer 214 generates a user interface for rule configuration on administrator device 104. Workflow designer 214 may provide an expression editor or state machine drag and drop for rule configuration, for example.

Workflow designer interface 214 is a rule management component with a user interface and UI components for managing and creating rules. Workflow designer interface 214 can add permissions to rules based on an organization structure, roles, and so on. Workflow designer interface 214 records audit data for rule execution and enables viewing of the audit data on what rules were fired on a file, and so on. Workflow designer interface 214 filters and sorts rules. Workflow designer interface 214 implements rule validation and conflict resolution (e.g. generate a priority order for rules).

Workflow designer interface 214 is a component that allows administrator devices 104 with the proper license and functions to be able to create rules for the workflow robot 200. These rules will be created using graphical state machine diagrams, where the user can drag and drop the parts of the diagram.

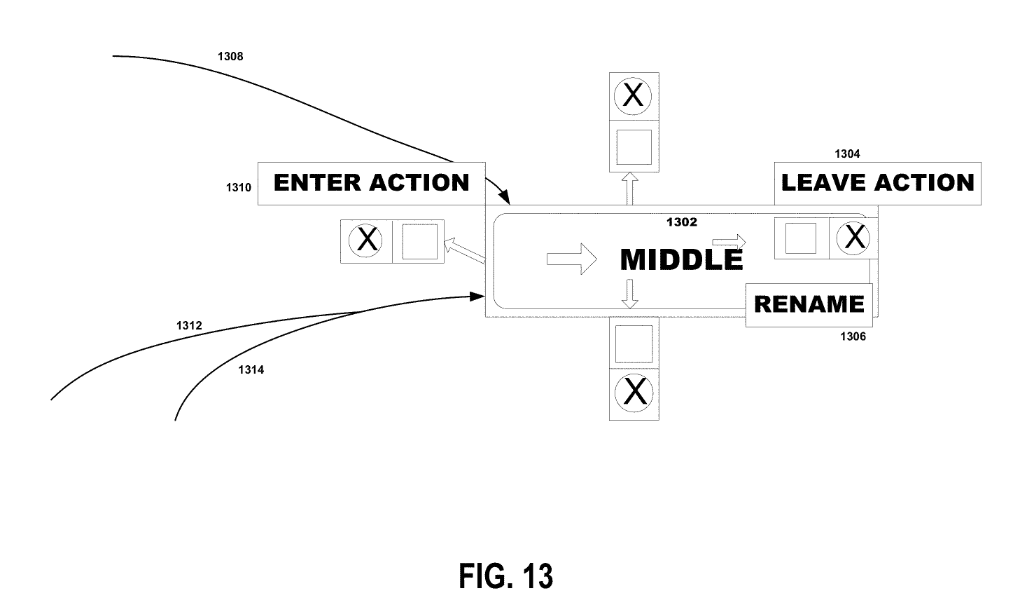

FIG. 13 depicts an aspect of the workflow designer interface 214. An administrator device 104 specifies actions to be taken before, during and after a particular state of a rule. An administrator device 104 may define certain actions to be performed prior to entering a given state (e.g. Enter Action 1310), certain actions to be performed subsequent to leaving a given state (e.g. Leave Action 1304) as well as captions for the state node.

For an existing condition for a node, there are options to delete and edit and rename the condition for the node. For example, clicking “edit” on a time-based trigger opens the time expire editor. For a middle node 1320, the workflow designer interface 214 defines the enter action 1310 and the leave action 1304. The administrator device 104 (via workflow designer interface 214) might only be able to work at one rule at a time in some embodiments. For example, the administrator device 104 might have to save the rule they are working on before working on another rule.

The middle node 1302 has different conditions 1308, 1312, 1314 before an enter action 1310 is executed. Conditions are set on the paths that lead from one node to another. Each node has an enter action and a leave action, which can be set to define what to do when that Node is reached. In the example of FIG. 10, the condition 1004 ( . . . ) can represent the condition File State=Closed, while the middle node 1006 can have an enter action that is set to send email notification to file owner.

Upon save, the workflow designer interface 214 converts the state machine diagram graphical representation of a rule into a file (e.g. JSON file), which will be saved to the rules table in the database 202. The rule file can be converted to machine language and saved in the same rules table in the database 202. To enable faster processing of rules, the machine language and binary representation of the rules is loaded into the workflow robot 200, and reloaded whenever there are changes in rules.

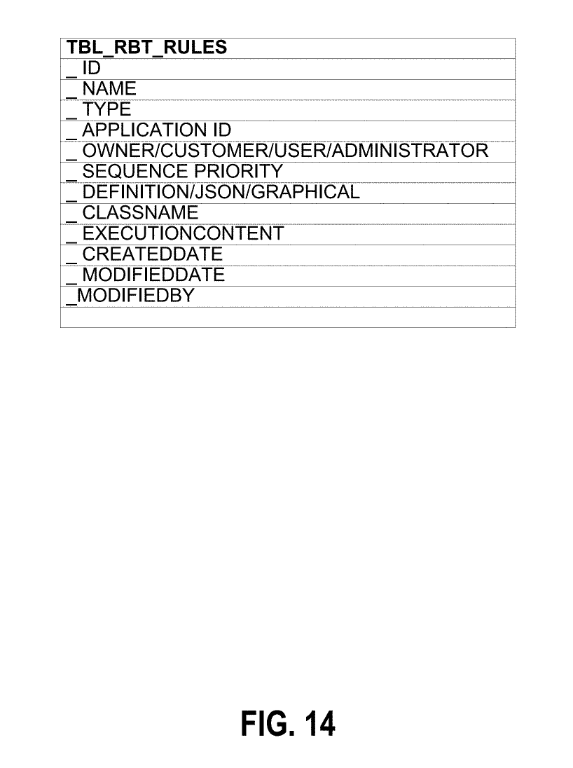

Workflow robot 200 includes database tables and DAL for rules. FIGS. 14 to 16 show example data structures for different tables of database 202.

The workflow robot 200 can use the following example tables (stored in database 202):
RULE
EVENTS_QUEUE
RULE_STATE

FIG. 14 depicts a data structure for a rules table. Each rule may define a data structure based on the fields of the rules table. In some embodiments, fields for a rule include: rule identifier, rule name, type (e.g. work flow rule, form rule, machine state rule), application identifier (e.g. feedback application of the workflow robot 200), owner (e.g. administrator identifier, user identifier, customer identifier), active status (e.g. a boolean value representing whether the rule should run or not), sequence priority (e.g. an ordinal value indicating the priority of a rule), definition (e.g. a JSON serialization of logic for the rule, data to define rule including triggers or conditions and actions), class name (e.g. a unique model reference identifier used to access the rule), execution content (e.g. the serialized rule data in JSON, XML or the like, binary to load rule), and timestamps indicating the time at which a rule was created and modified, and the administrator device 104 that created or modified the rule most recently. These are example fields for a data structure that defines a rule.

The RULES table stores all the rules or models managed by rule engine 206. These rules are created and configured as state machine diagrams using the workflow designer interface 214.

When the administrator device 104 is creating rules via the workflow designer interface 214, the priority or order of execution for the rules will also be set. This priority or order determines the order in which the rules are executed by the workflow robot 200. If there is a conflict of rules that are relevant for a particular file, workflow robot 200 selects the rule that has greater priority (based on the ordering set by the administrator device 104).

When the workflow robot 200 receives an event entry from the event queue 318, it locates the file(s) associated with the event. After that, workflow robot 200 iterates through all the rules to identify rules that deal with the particular file. If a rule deals with that file, the workflow robot 200 executes the rule to evaluate the conditions and takes the actions of the rule.

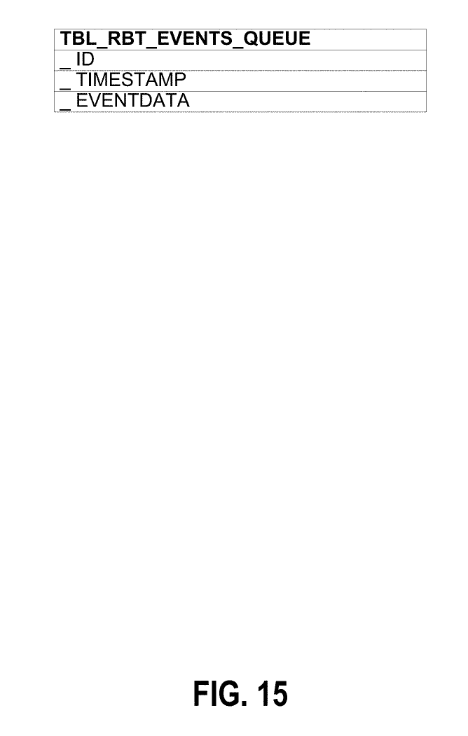

FIG. 15 depicts a data structure for event entries for the event queue 318 that are added when the rule interception component 316 detects events. An event entry includes a timestamp and serialized event data indicating the object upon which rules should be executed. An event entry also includes an identifier. The event entry also includes EventData that includes a reference to an object to which the event relates (e.g. a file identifier). The rules engine 206 may retrieve a serialized file object from the event queue 318 and begin and/or continue execution of rules on that file.

The event queue 318 is a component of the database 202 that builds and manages event entries or messages for the workflow robot 200. The event queue 318 has an asynchronous operation to add event entries and process event entries asynchronously.

Independent events occur in workflow system 100 which trigger a signal to activate the workflow robot 200. Upon the occurrence of events, new event entries are added to the event queue 318. These events can be:
Time-based triggers
Triggers based changes in files
Triggers based on information from other streams of data, such as HL7 feed, external systems, user systems and so on

These event entries are saved in an event queue 318 (e.g. table) in the database 202. In some embodiments, the workflow robot 200 retrieves event entries in a first-in-first-out order. The workflow robot 200 looks at the file identifier which is saved in the event data field of the data structure for an event entry.

Using the file identifier, the workflow robot 200 looks in the RULE_STATE table and finds the corresponding state for that file, and determines what action to take on the file.

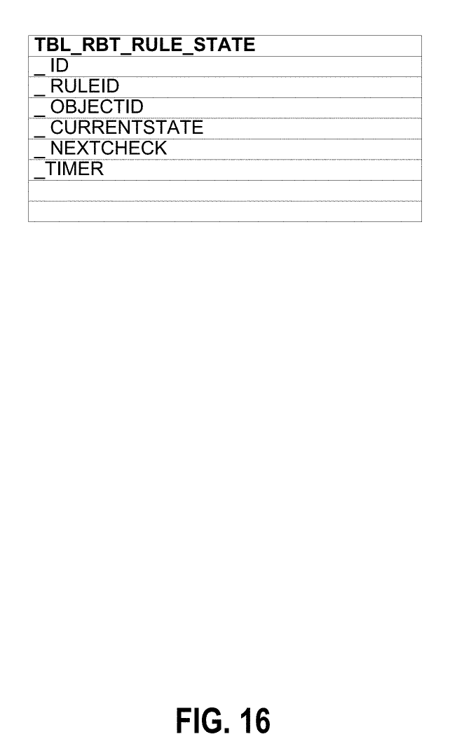

FIG. 16 depicts a data structure with fields for a Rule State Table according to some embodiments. The rule state indicates the state for values of objects as rules may have different states. In some embodiments, the Rule State Table has a many-to-many database table. A Rule State Table has fields that specify an object identifier (such as the identifier value of a file in the database 202) and a rule identifier. The Rule State Table may specify the current State of the object in linked to the event as well as the time at which the rules engine 206 should check both the rule and object for its current State 116. As an illustrative example, if a particular rule has been executed on a file and progressed to “State 2” of the rule, but has not progressed to “State 3” of the rule, the following may be stored in the Rules State Table 440: the rule identifier, the file identifier, and “State 2.” This data would tell the rules engine 206 that the particular file is in “State 2” with respect to the particular rule.

The Rule State Table keeps track of all the rules for all the files which have any associated trigger and the state of the rules for those files. A rule might be in different states for different files. Within a rule, to go from one state to another would require a condition. There are three types of these condition for changes to the state:
Immediate condition
Time based condition
Expression based condition

The object identifier can be a file identifier in the case of data from the healthcare workflow system 100. The workflow robot 200 gets the file identifier from the EVENTS_QUEUE table 318 and then checks in the RULE_STATE table to determine the current state of the file. Based on the state, the workflow robot 200 executes the rule for the file. The RULE_STATE table is updated every time there is a change in the state of any of the models.

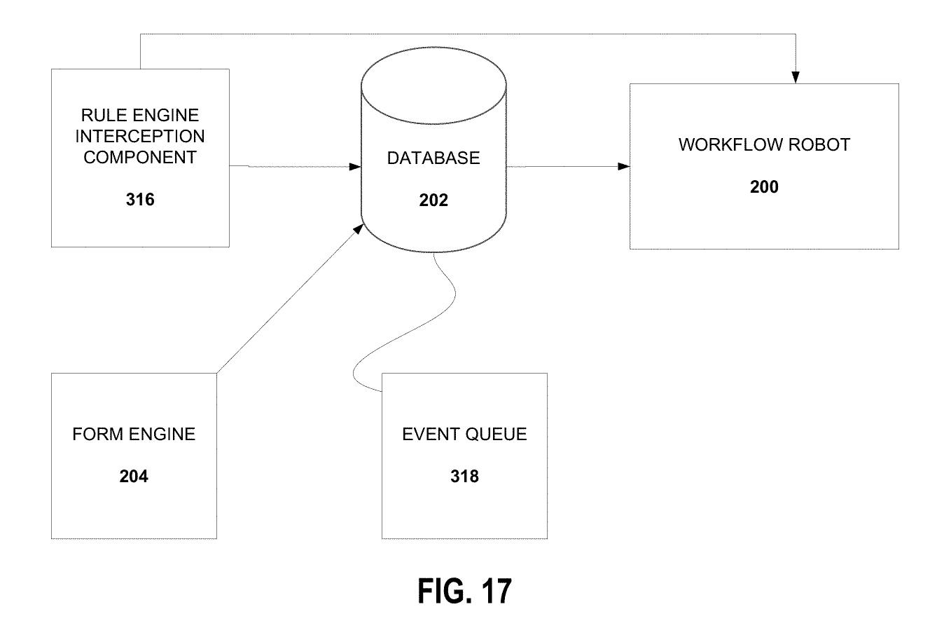

FIG. 17 is a diagram showing interactions by rule engine interception component 316, form engine 204, database 202 (and event queue 318) and workflow robot 200. A form engine 204 may generate a form and receive data to update a patient file in database 202. The rule engine interception component 316 intercepts the updated patient file as a detected event and in response generates a new event entry for the event queue 318. When the new event entry is added to the event queue 318 a signal activates the workflow robot 200. The workflow robot 200 identifies rules relevant to the event entry and implements actions based on the rules to automate workflow system 100. This is an example.

The workflow robot 200 may poll the Event Queue 318 periodically on a time based interval (e.g. 30 minutes). The rules engine interception component 316 sends a signal to the workflow robot 200 to check the event queue 318 after the rules engine interception component 316 has added a new event entry to the event queue 318. In another embodiment, rather than the rules engine interception component 316 sending a signal to the workflow robot 200, the database 202 may send a signal to activate the workflow robot 200 (to check the event queue 318) after changes have been made to the database 202.

The present system and method may be implemented using different computer devices including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The embodiments described herein involve computing devices, servers, receivers, transmitters, processors, memory, display, networks particularly configured to implement various acts. The embodiments described herein are directed to electronic machines adapted for processing and transforming electromagnetic signals which represent various types of information. The embodiments described herein pervasively and integrally relate to machines. Substituting the computing devices, servers, receivers, transmitters, processors, memory, display, networks particularly configured to implement various acts for non-physical hardware, using mental steps for example, may substantially affect the way the embodiments work. Such computer hardware limitations are essential elements of the embodiments described herein, and they cannot be omitted or substituted for mental means without having a material effect on the operation and structure of the embodiments described herein. The computer hardware is essential to the embodiments described herein and is not merely used to perform steps expeditiously and in an efficient manner.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

While illustrated in the block diagrams as groups of discrete components communicating with each other via distinct electrical data signal connections, the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching example embodiments.

It will be appreciated by those skilled in the art that other variations of the embodiments described herein may also be practiced without departing from the scope of the invention. Other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be understood by those skilled in the relevant arts, with respect to both processes and any systems, devices, etc., described herein, a wide range of variations is possible, and even advantageous, in various circumstances, without departing from the scope of the invention, which is to be limited only by the claims.

### Other Applications

The description describes potential applications that may be practiced in regards to some embodiments. There may be other, different, modifications, etc. of the below potential applications, and it should be understood that the description is provided as non-limiting, illustrative examples only. For example, there may be additions, omissions, modifications, and other applications may be considered.

The rules engine of the present disclosure may be implemented in a variety of workflow settings. For example, a law enforcement agency could implement a rules engine similar in substance to the one described in the present disclosure into the law enforcement agency's workflow to automate various tasks and file operations based on changes to the dataset of its workflow: when a new case is opened, for example, the rules engine may send notifications and modify file properties based on predefined rules. Similarly, an education institution may implement the rules engine as part of its workflow related to student files: when a new student enters the educational institution, the rules engine may be activated as well as when various properties are changed on the student file involving courses completed or enrollment status. The possibilities for implementing the rules engine into non-healthcare workflows are therefore far-reaching.

The rules engine of the present disclosure may also be implemented in a variety of non-workflow-related settings. For example, the rules engine might be implemented in corporate computing environments allowing administrators of the computing environment to define rules to be executed asynchronously from file operations. Similarly, the rules engine might be implemented in consumer products that contain file systems, allowing users to define rules to be executed upon modifications of the file system of such consumer products (personal computers, tablets, and mobile devices, for example). As such, the possibilities for implementing the rules engine into non-workflow computing environments are very far-reaching.

What is claimed is:

1. A healthcare workflow robot comprising a processor and a persistent data store with machine-readable instructions to configure the processor to provide:
a form engine to generate a form interface to receive or update healthcare data for the persistent data store;
a rules engine interception component to:
detect events through an application programming interface, an auxiliary business logic layer, or an auxiliary data access layer, the events based on received or updated healthcare data from the form interface;
store event entries for the detected events to an events queue stored in the persistent data store, the event entries include data indicating changes that have been made to files and/or non-file-related actions; and
activate the workflow robot when the event entries are stored to the events queue;
a rules engine to:
identify a set of rules stored in the persistent data store in response to activation of the robot by the rule engine interception component or upon expiration of a time, each rule having a trigger and an action, the action relating to the healthcare data in the persistent data store;
iterate the set of rules to evaluate each rule for execution of the action of the rule based on the event entries and the trigger of the rule; and
a workflow designer interface to generate visual elements for creating, modifying and deleting a rule of the set of rules by creating, modifying and deleting logical expressions for the trigger and the action using the visual elements.

2. The healthcare workflow robot of claim 1, wherein each rule of the set of rules includes a plurality of states, each state having a set of triggers, actions, and one or more linkages to other states; and
wherein, when evaluating each rule for execution, a current state of the rule is used to apply a corresponding trigger and a corresponding action for evaluation.

3. The healthcare workflow robot of claim 2, wherein the execution of the action of at least one of the rules includes transitioning the rule from a current state to another state using a linkage.

4. The healthcare workflow robot of claim 3, wherein each action is associated with a priority ranking;
wherein evaluation of each rule for execution of the action includes identifying conflicts between the execution of the action and the execution of other actions; and
wherein the priority ranking of each action is utilized to determine which actions should be executed and which actions should be ignored.

5. The healthcare workflow robot of claim 4, further comprising a binary executable encapsulation engine, the binary executable encapsulation engine configured to activate the rules engine to iterate the set of rules to identify a complete set of actions and triggers indicative of the current states of all rules; and
encapsulate a point-in-time binary executable representative of the complete set of actions and triggers, the point-in-time binary executable used for the activation of the workflow robot to execute the actions in response to events.

6. The healthcare workflow robot of claim 5, wherein the complete set of actions is representative only of the actions identified for execution in accordance with the priority ranking of each action.

7. The healthcare workflow robot of claim 6, wherein the binary executable encapsulation engine is configured to regenerate a new point-in-time binary executable when new event entries are intercepted.

8. The healthcare workflow robot of claim 7, wherein the regeneration a new point-in-time binary executable when new event entries are intercepted only occurs when a state transition is executed.

9. The healthcare workflow robot of claim 1, further comprising an alert engine to generate an alert notification based in the action relating to the health care data.

10. The healthcare workflow robot of claim 1, wherein the rules interception component adds event entries to the event queue asynchronously to the robot processing the event entries.

11. A process for execution of file-related rules by a healthcare workflow robot, the process comprising:
polling an event queue for new event entries or receiving a signal indicating one or more new event entries in the event queue;
locking a file in a data store;
creating or determining a batch set of rules based on the one or more new event entries in the event queue;
ordering the batch set of rules based on a predefined parameter;
iterating through the batch set of rules to evaluate a trigger on each rule, execute an action if the trigger is met, and determine whether all rules have been executed;
examining whether a dataset of the data store has been changed during execution of the rules and re-initiating execution of the batch set of rules if the dataset of the database has changed; and
unlocking the file in the data store.

12. A healthcare workflow system comprising:
a rules engine residing within a healthcare workflow robot that has or integrates with a form engine that renders a form interface for a user device to generate a form, wherein the form creates, modifies and deletes healthcare data associated with patient files, the healthcare data passing through one or more layers of the healthcare workflow robot including application programming interfaces, business logic layers and data access layers before being saved to the database; and
a rules interception component that intercepts the healthcare data related to the patient files as it passes from business logic and data access layers of the healthcare workflow robot, upon intercepting such data, creates event entries in the event queue, and sends a signal to activate the healthcare workflow robot indicating that new event entries are in the event queue, the healthcare workflow robot processing the event entries using the rules engine to evaluate and execute rules for a particular file associated with the intercepted data and event entries.

13. The healthcare workflow system of claim 12, wherein the rules interception component adds event entries to the event queue asynchronously to the workflow robot processing the event entries.

14. The system of claim 12, further comprising workflow designer interface for creating and updating the rules for the healthcare workflow robot, the rules evaluated in response new event entries in the event queue, the event entries for additions, updates and deletions to healthcare data in a persistent data store by a form interface on a client device, the workflow designer interface comprising at least two visual panels to create and update rules for the rules engine using graphical or visual elements representing states, triggers, conditions and connections.

15. The workflow designer interface of claim 14, wherein the rules created through the workflow designer interface are precompiled into machine-readable code after an administrator device creates or modifies the rules.

16. The workflow designer interface of claim 14, wherein the workflow designer interface defines a priority sequence for the rules in a rule-execution workflow.

17. The healthcare workflow system of claim 12, wherein the rules engine interception component is configured to:
listen for impending changes to files in a database performed by a file save business logic layer and a file save data access layer and the execution of non-file-related actions through an auxiliary business logic layer and an auxiliary data access layer of the workflow robot;
save to an event queue of event entries, each event entry comprising data indicating changes that have been made to the files in the database and/or non-file-related actions that have been performed by the workflow robot; and
allow the impending changes to the files in the database to proceed;
the event queue in which the rules engine interception component stores the event entries;
the set of rules for which execution thereof is initiated by the rules engine polling the event queue of event entries for new event entries or activation of the workflow robot in response to the new event entries in the event queue, each rule having a trigger to be evaluated for execution of an action, the action to modify files in the data store based on the content of the event entry and the result of the evaluation of the trigger, wherein the rules engine iterates the set of rules after discovering new event entries in the event queue.

18. The rules engine of claim 17, wherein the workflow designer interface is comprised of at least two visual panels, the first of which contains workflow objects and logical operands that are adapted to be dragged and dropped to the second panel in order to form logical expressions for the rules.

19. The rules engine of claim 17, wherein the rules created through the workflow designer interface are precompiled into machine-readable code after the administrator creates or modifies the rules.

20. The rules engine of claim 17, wherein a rule of the rules created through the workflow designer interface includes data indicating the priority of that rule in a rule-execution workflow.
